(19) United States
(12) Patent Application Publication
(10) Pub. No.: US 2016/0125474 A1
(43) Pub. Date: May 5, 2016

(54) PREINSTALL PARTNER REVENUE SHARING

(71) Applicant: QUIXEY, INC., Mountain View, CA (US)

(72) Inventors: Christopher Hoffman, San Luis Obispo, CA (US); Shivshankar Sundar, Santa Clara, CA (US)

(21) Appl. No.: 14/527,664

(22) Filed: Oct. 29, 2014

(51) Int. Cl. G06Q 30/02

(52) U.S. Cl. CPC G06Q 30/0274; G06Q 30/0267

(57) ABSTRACT

An example method includes providing an application and a partner attribution identifier to a partner device, the partner attribution identifier configured to identify a preinstall partner and configured to be stored on a user device before the user device is first sold to an end user, the application configured to assist in presenting an advertisement, selecting the advertisement for display on the user device, the advertisement being associated with an advertisement identifier, receiving the partner attribution identifier from the user device, associating the advertisement identifier with the partner attribution identifier, receiving advertisement revenue information associated with revenue related to the advertisement, the advertisement revenue information including the advertisement identifier, identifying the preinstall partner using the partner attribution identifier associated with the advertisement identifier, and allocating a share of the revenue to the preinstall partner.

### TECHNICAL FIELD

The present disclosure generally relates to advertisement revenue sharing and, more particularly to techniques for advertisement revenue sharing with partners that preinstall software applications on digital devices.

### BACKGROUND

Manufacturers, distributors, and carriers are facing challenges of increasing competition while expanding distribution. As a result, manufacturers, distributors, and carriers are constantly looking for opportunities to increase revenue.

Mechanisms for the manufacturers, distributors, and carriers to increase revenue include expanding hardware and software capability. Operating systems and graphical user interfaces (GUIs) are differentiated to provide a wide variety of choices to demanding consumers. Further, manufacturers, distributors, and carriers are preinstalling different software applications on mobile devices prior to sale in exchange for one-time revenue from software application developers or other commercial advantage.

### SUMMARY

In various implementations, an example system includes one or more computing devices. The one or more computing devices may include a preinstall partner module, an advertisement generation module, a partner attribution identifier module, and a revenue attribution module. The preinstall partner module may be configured to provide an application and a partner attribution identifier to a partner device. The partner attribution identifier may be configured to identify a preinstall partner. The partner attribution identifier may be further configured to be stored on a user device before the user device is first sold to an end user. The application may be configured to assist in presenting an advertisement. The advertisement generation module may be configured to select the advertisement for display on the user device. The advertisement may be associated with an advertisement identifier. The partner attribution identifier module may be configured to receive the partner attribution identifier from the user device and to associate the advertisement identifier with the partner attribution identifier. The revenue attribution module may be configured to receive advertisement revenue information associated with revenue related to the advertisement. The advertisement revenue information may include the advertisement identifier. The revenue attribution module may be further configured to identify the preinstall partner using the partner attribution identifier associated with the advertisement identifier, and to allocate a share of the revenue to the preinstall partner.

The one or more computing devices may further include an application search module configured to receive a search query from the application on the user device after the user device is sold to the end user, to provide search results to the user device, and to provide the selected advertisement to the user device. The search results may be determined using the search query. In various embodiments, the search query includes the partner attribution identifier. The partner attribution identifier may be stored in read-only memory on the user device.

In some embodiments, the one or more computing devices further include a partner identification module configured to store an association between the partner attribution identifier and the preinstall partner. The revenue attribution module may be further configured to generate a report identifying at least a portion of the revenue to be provided to the preinstall partner.

The one or more computing devices may further include a revenue rules data store configured to store at least one revenue rule associated with revenue attribution of the preinstall partner. The revenue attribution module may be further configured to retrieve the at least one revenue rule from the revenue rules data store and, to allocate the share of the revenue to the preinstall partner, determine an allocation of a portion of the revenue to the preinstall partner using the at least one revenue rule.

In some implementations, the advertisement identifier comprises a session identifier or a timestamp associated with selection of the advertisement or sending of the advertisement to the user device. The advertisement may comprise advertisement linking information to enable the application on the user device to retrieve the advertisement.

In some embodiments, the one or more computing devices further include a security module configured to receive a security identifier from the user device and authenticate the security identifier.

Some aspects of the disclosure provide a method comprising providing, to a partner device, an application and a partner attribution identifier, at least the partner attribution identifier of which is configured to be stored on a user device before the user device is first sold to an end user. The partner attribution identifier is further configured to identify a preinstall partner in some examples. The application is configured to assist in presenting an advertisement. The method may further comprise selecting the advertisement for display on the user device, the advertisement being associated with an advertisement identifier, receiving the partner attribution identifier from the user device, associating the advertisement identifier with the partner attribution identifier, receiving advertisement revenue information associated with revenue related to the advertisement, the advertisement revenue information including the advertisement identifier, identifying the preinstall partner using the partner attribution identifier associated with the advertisement identifier, and allocating a share of the revenue to the preinstall partner.

Further, some aspects of the disclosure provide a system including non-transitive memory comprising executable instructions. The instructions may be executable by a data processing device to perform a method. The method may comprise providing, to a partner device, an application and a partner attribution identifier, at least the partner attribution identifier of which is configured to be stored on a user device before the user device is first sold to an end user. The partner attribution identifier is further configured to identify a preinstall partner in some examples. The application is configured to assist in presenting an advertisement. The method may further comprise selecting the advertisement for display on the user device, the advertisement being associated with an advertisement identifier, receiving the partner attribution identifier from the user device, associating the advertisement identifier with the partner attribution identifier, receiving advertisement revenue information associated with revenue related to the advertisement, the advertisement revenue information including the advertisement identifier, identifying the preinstall partner using the partner attribution identifier associated with the advertisement identifier, and allocating a share of the revenue to the preinstall partner.

### BRIEF DESCRIPTION OF THE DRAWINGS

FIG. 1 is an illustration of an environment including a preinstall system, a revenue attribution system, an advertisement system, a search system, and a user device each in communication over a network in some embodiments.

FIG. 2 is an illustration of an example user device with a stock ROM including a search application and a partner attribution identifier in some embodiments.

FIG. 3 illustrates an example method performed by a user device to identify and provide a partner attribution identifier to a device, such as a revenue attribution system, an advertisement system, or a search system in some embodiments.

FIG. 4 illustrates an example method for attributing a portion of revenue in some embodiments.

FIG. 5A is an illustration of an example GUI on a user device that includes search results and an advertisement in some embodiments.

FIGS. 5B-5D are images of an example search application that depict a process for determining if a partner attribution identifier or a default partner identifier is detected by the search application in some embodiments.

FIG. 6 shows an example application search module that may be included in a search system in some embodiments.

FIGS. 7A-7B illustrate example application records in some embodiments.

FIG. 8 shows an example method for performing a search for applications in some embodiments.

FIG. 9 is a functional block diagram that illustrates example interactions between a user device, an advertisement system, and a search system in some embodiments.

FIG. 10 illustrates an example advertisement record in some embodiments.

FIG. 11 is a functional block diagram of an example advertisement generation module that includes an advertisement identification module and an advertisement selection module in some embodiments.

FIG. 12 illustrates an example method for generating search results and an advertisement for the search results in some embodiments.

FIG. 13 is a functional block diagram of a digital device in some embodiments.

Like reference symbols in the various drawings indicate like elements.

### DETAILED DESCRIPTION

Techniques are described herein for attributing revenue generated from advertising to a partner (i.e., a preinstall partner) that preinstalled a software application on a user device before the user device is first sold or otherwise entered into commerce. In one example, advertising revenue generated by a search application may be attributed to a device manufacturer that preinstalled the search application on a smartphone prior to sale of the smartphone to an end user. An application developer (e.g., Quixey) may provide the preinstall partner with the software application (e.g., a search application) and an attribution file that includes a partner attribution identifier. The partner attribution identifier identifies the preinstall partner that preinstalled the application. The preinstall partner may include the application and the attribution file in a stock ROM (e.g., a file image) to be installed on a new user device (e.g., a smartphone, tablet, or other computing device). A portion of revenue generated for the application developer through advertising displayed on the application (e.g., advertisement revenue) may be attributed to the preinstall partner based on the partner attribution identifier included in the attribution file.

The software application may display advertisements that generate revenue for the application developer. Revenue generated by the advertisements may be determined using any number of advertising models, including, but not limited to: a) cost per number of impressions (e.g., number of views), b) cost per click-through, and c) cost per action (e.g., download). According to the cost per number of views model, an advertiser agrees to pay a specified amount each time an advertisement is displayed a specified number of times on the user device (e.g., displayed on the user device by the application). According to the cost per click-through model, the advertiser agrees to a pay a specified amount each time a user clicks on the advertisement displayed on the user device by the application. According to the cost per action model, the advertiser agrees to pay a specified amount each time a user performs a specific action in response to display of the advertisement on the user device by the application. For example, the advertiser can agree to pay a specified amount when the user clicks on a hyperlink in the advertisement and makes a purchase, installs an application from a site associated with the advertisement, or registers.

In various embodiments, the attribution file is stored in protected and/or read-only memory of the user device. As a result, the attribution file may not be overrun (e.g., modified, deleted, or overwritten) if the software application is removed from the user device or changed. For example, the attribution file may not be affected when the application preinstalled by the preinstall partner is modified, deleted, or overwritten. As a result, in some embodiments, regardless of what happens to the application, the attribution file (including the partner attribution identifier) may not be altered or lost and the preinstall partner may not lose revenue attribution.

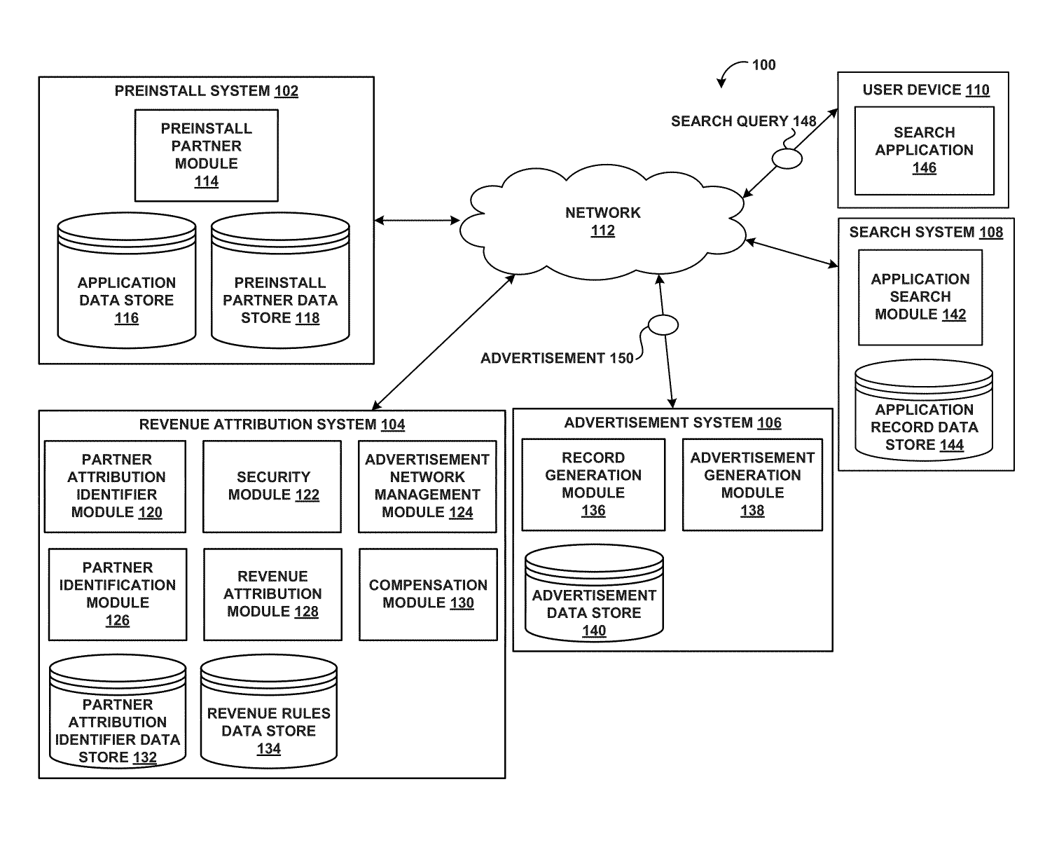

FIG. 1 is an illustration of an environment 100 including a preinstall system 102, a revenue attribution system 104, an advertisement system 106, a search system 108, and a user device 110 each in communication over a network 112 in some embodiments. The network 112 may include various types of networks, such as a local area network (LAN), a wide area network (WAN), and/or the Internet.

The preinstall system 102 includes a preinstall partner module 114, an application data store 116, and a preinstall partner data store 118. In various embodiments, an application developer (e.g., Quixey) develops a software application for installation on a user computing device (e.g., a search application 146 included on the user device 110), such as a mobile computing device (e.g., a smartphone, tablet, smart watch, or the like). The application may be the search application 146 or any other application. The application may display advertisements 150 selected by the advertisement system 106 and generate advertisement revenue.

A software application may refer to computer software that causes a computing device to perform a task. In some examples, a software application may be referred to as an “application,” an “app,” or a “program.” Example applications include, but are not limited to, document viewing applications, messaging applications, media streaming applications, social networking applications, and games.

Applications can be executed on a variety of different computing devices. For example, applications can be executed on mobile computing devices such as smartphones, tablets, and wearable computing devices (e.g., headsets and/or smart watches). Applications can also be executed on other types of computing devices having other form factors such as laptop computers, desktop computers, or other consumer electronic devices. In some examples, applications may be installed on a computing device prior to a user purchasing the computing device. In other examples, the user may download and install applications on the computing device after purchasing the computing device.

The preinstall system 102 may be configured to provide a preinstall partner (e.g., a partner device of the preinstall partner) with an application and an attribution file including a partner attribution identifier. A partner device, as used herein, is any digital device that may distribute the application and the attribution file on any number of user devices 110 prior to sale of the user device(s) 110. In some implementations, the preinstall partner (e.g., the partner device) may generate a stock ROM or file image including the application and the attribution file. The stock ROM or file image, including the application and the attribution file, may be preinstalled on a user device 110 prior to sale of the user device 110 to an end user.

A preinstall partner, as used herein, may refer to one or more parties (e.g., user device manufacturers, service providers such as smartphone carriers, and/or other parties) that sell, resell, or otherwise distribute user devices 110. As discussed herein, the preinstall partner may generate the stock ROM for preload of the application and the attribution file on the user device 110 prior to sale of the user device 110. The stock ROM may refer to or include a set of files such as, for example, an operating system, applications, and the attribution file as described herein. In some implementations, a manufacturer preloads a SAMSUNG® smartphone developed by Samsung Electronics Co., Ltd. with the stock ROM for a reseller, such as a cell phone carrier (e.g., VERIZON® by Verizon Trademark Services LLC).

The preinstall partner module 114 may be configured to manage distribution of applications, partner attribution identifiers, and/or attribution files to partner devices (i.e., to preinstall partners) for preinstallation on user devices 110. Preinstallation of the applications, partner attribution identifiers, and/or attribution files on a user device 110 may refer to installation of the applications, partner attribution identifiers, and/or attribution files prior to the user device 110 being first sold to an end user.

In various embodiments, the preinstall partner module 114 may receive an application to distribute to one or more preinstall partners. The preinstall partner module 114 may store the application in the application data store 116. One or more applications stored by the preinstall partner module 114 in the application data store 116 may be stored as packages. For example, the one or more applications may be included in or packaged as an ANDROID® operating system package (.apk). In some examples, the same application may be installed on multiple user devices 110 using different distribution techniques. For example, the same application (e.g., Quixey's search application) may be used as a preload, as a download on a digital distribution platform (e.g., GOOGLE PLAY® developed by Google Inc.), or as a sideload. Additionally, in some embodiments, an application developer may not be required to custom-compile different packages (e.g., ANDROID® operating system packages) of an application for one or more preinstall partners. For example, the same .apk for an application may be applied to multiple different distribution techniques and preinstall partners. Accordingly, a preinstall partner may install the same .apk file (bit-for-bit in some examples) that an application developer provides to any number of other preinstall partners.

The preinstall partner module 114 may receive any number of applications. For example, the preinstall partner module 114 may receive a number of different applications (e.g., utility applications, gaming applications, or the like) for one or more different platforms (e.g., GOOGLE ANDROID®, MICROSOFT WINDOWS®, or APPLE IOS®). In some embodiments, different applications may be associated with different preinstall partners. For example, Samsung Electronics Co., Ltd may prefer to distribute a particular version of an application for specific SAMSUNG® devices and/or particular versions of a preferred operating system. Similarly, HTC Corporation may prefer a different version of the same application (e.g., for different devices and/or versions of an operating system).

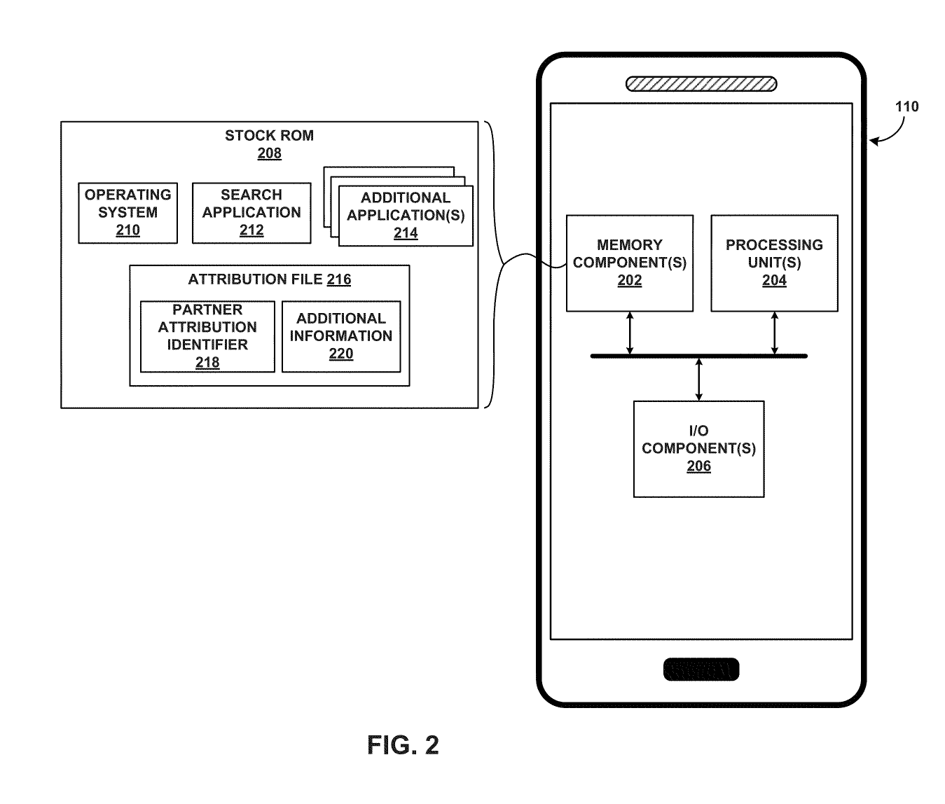

The preinstall partner module 114 may receive and store any number of partner attribution identifiers (e.g., the partner attribution identifier 218 of FIG. 2) in the preinstall partner data store 118. A partner attribution identifier may be any identifier that identifies a preinstall partner or any entity or device that is to receive attribution of revenue. In some embodiments, each partner attribution identifier uniquely identifies one preinstall partner.

In some implementations, the preinstall system 102 may receive preinstall partner instructions. The preinstall partner instructions may include instructions regarding which application(s) from the application data store 116 and which partner attribution identifier from the preinstall partner data store 118 to provide to a preinstall partner (e.g., to a partner device of the preinstall partner).

In some embodiments, the preinstall system 102 may receive, from a preinstall partner, a preinstall partner request for an application and/or a partner attribution identifier. The preinstall system 102 may retrieve preinstall partner instructions associated with the requesting preinstall partner (e.g., from the preinstall partner data store 118) and, using the preinstall partner instructions, identify one or more applications from the application data store 116, identify a partner attribution identifier from the preinstall partner data store 118, and/or provide the identified application(s) and the identified partner attribution identifier to the requesting preinstall partner.

In some embodiments, the preinstall system 102 may confirm, authenticate, determine authorization, and/or verify the preinstall partner request before identifying and/or providing the application(s) and/or the partner attribution identifier as described above.

After the partner device receives the application(s) and/or the partner attribution identifier, the partner device (or a related digital device) may create a stock ROM as discussed herein (e.g., the stock ROM 208 of FIG. 2) for preinstallation on the user device 110. The partner device of the preinstall partner or another device may install the stock ROM on the user device 110 (e.g., in flash memory) before the user device 110 is sold.

The attribution file, including the partner attribution identifier, may be located in a specific location in memory of the user device 110 such that for every updated or new stock ROM the preinstall partner or another entity distributes to the user device 110, the attribution file (including the partner attribution identifier) may remain unaffected. For example, if the attribution file is located in a read-only memory of the user device 110, then the preinstall partner may receive attribution even if changes are later made to the user device 110 (e.g., to the stock ROM included on the user device 110).

The application data store 116 may include any number of applications such as the search application 146 to be installed on any number of user devices 110. The application data store 116 may include one or more databases, indices (e.g., inverted indices), files, or other data structures which may be used to implement the techniques of the present disclosure.

The preinstall partner data store 118 may include any number of attribution files and/or partner attribution identifiers to be installed on any number of user devices 110. In some embodiments, the preinstall partner data store 118 may include preinstall partner instructions as described herein. The preinstall partner data store 118 may include one or more databases, indices (e.g., inverted indices), files, or other data structures which may be used to implement the techniques of the present disclosure.

The revenue attribution system 104 may receive payments from advertisers for showing advertisements 150 using the application(s). The revenue attribution system 104 may determine a portion of the payments to be attributed to the preinstall partner using the partner attribution identifier. In some embodiments, the revenue attribution system 104 may share the attributed payments, or revenue, with any number of preinstall partners. For example, the revenue attribution system 104 may attribute and/or share money received from an advertisement source (e.g., an advertisement network) with preinstall partners that preinstalled an application (e.g., the Quixey application).

Generally, in some embodiments, the revenue attribution system 104 may associate a partner attribution identifier received from a user device 110 with an advertisement identifier. The advertisement identifier may identify an advertisement 150 that is directed, or transmitted, to the user device 110 for display using an application (e.g., the search application 146). If a compensation event associated with the advertisement 150 (e.g., an impression, click-through, or engagement) is triggered, then revenue may be provided by an advertiser associated with the advertisement 150. A compensation event is any event associated with triggering revenue from an advertiser. The revenue attribution system 104 may identify the partner attribution identifier associated with the advertisement identifier that identifies the advertisement 150 that generated the revenue. The revenue attribution system 104 may attribute a portion of the revenue to the preinstall partner identified by the partner attribution identifier.

In some embodiments, an advertising analytics system (not shown in FIG. 1) may detect when a compensation event has occurred and provide notice to the revenue attribution system 104, the advertisement system 106, an advertiser device (e.g., prompting an advertiser to agree to pay revenue upon the occurrence of the compensation event), and/or any other device. As discussed herein, revenue generated by an advertisement 150 may be triggered on any number of events, including, but not limited to: a) cost per number of impressions (e.g., number of views), b) cost per click-through, and c) cost per action (e.g., download).

In one example, the advertisement system 106 may provide an advertisement 150 and/or advertisement codes with an advertising analytics code (e.g., a token, identifier, beacon, and/or URL). Using the advertising analytics code, the advertising analytics system may be notified when the advertisement 150 is displayed, clicked on, or otherwise engaged (e.g., associated with a download). Advertising analytics systems may identify a compensation event in any number of ways.

Once the advertising analytics system detects a compensation event, the advertising analytics system may provide a notice of the compensation event (i.e., advertising revenue information), including an advertisement identifier that identifies an advertisement 150 that triggered the compensation event, to the revenue attribution system 104, an advertiser associated with the advertisement 150, or any other device. The notice may include or be part of a report provided to an application developer and/or the revenue attribution system 104 describing compensation and other information.

For example, the revenue attribution system 104 may receive an advertising revenue report from an advertiser and/or the advertising analytics system. The advertising revenue report may include advertising revenue information. The advertising revenue information may include an advertisement identifier identifying an advertisement 150 that generated revenue (i.e., that triggered a compensation event) as well as an amount of the revenue. The revenue attribution system 104 may identify a partner attribution identifier associated with the advertisement identifier, and attribute a portion of the revenue to a preinstall partner identified by the partner attribution identifier.

The revenue attribution system 104 may include a partner attribution identifier module 120, a security module 122, an advertisement network management module 124, a partner identification module 126, a revenue attribution module 128, a compensation module 130, a partner attribution identifier data store 132, and a revenue rules data store 134. In various embodiments, the partner attribution identifier module 120 may receive a partner attribution identifier from a user device 110.

The user device 110 may provide the partner attribution identifier to the partner attribution identifier module 120 in any number of ways and any number of times. For example, an application included on the user device 110 (e.g., the search application 146, which may have been preinstalled on the user device 110 as a part of the stock ROM 208 of FIG. 2) may provide the partner attribution identifier to the partner attribution identifier module 120. In a more specific example, the search application 146 included on the user device 110 may provide a query wrapper that includes a search query 148 to the search system 108 and/or the revenue attribution system 104. The query wrapper and/or the search query 148 may include the partner attribution identifier from the user device 110. The partner attribution identifier module 120 may receive the partner attribution identifier (e.g., from the query wrapper and/or the search query 148, or from the search system 108). The partner attribution identifier may be retrieved and provided to the partner attribution identifier module 120 in any number of ways.

In various embodiments, the partner attribution identifier module 120 may associate the partner attribution identifier received from the user device 110 with any information to assist with identifying revenue (e.g., for an advertisement 150 displayed on the user device 110) and assist in identification of a portion of the revenue to provide to the preinstall partner associated with the partner attribution identifier. In one example, the advertisement system 106 may select an advertisement 150 to be displayed on the user device 110. The advertisement system 106 may provide an advertisement identifier that identifies the advertisement 150 to the partner attribution identifier module 120. The partner attribution identifier module 120 may associate the partner attribution identifier received from the user device 110 with the advertisement identifier. Subsequently, the partner attribution identifier module 120 may store the partner attribution identifier, the advertisement identifier, and the association between the partner attribution identifier and the advertisement identifier in the partner attribution identifier data store 132.

In some implementations, the partner attribution identifier module 120 may associate a partner attribution identifier received from a user device 110 with a device identifier of the user device 110 (e.g., a media access control (MAC) address). As such, in some embodiments, a compensation event may be associated with a user device 110 (and a device identifier of the user device 110), rather than with an advertisement identifier that identifies an advertisement 150 that triggered generation of revenue. The revenue attribution system 104 may identify the partner attribution identifier based on the device identifier and, subsequently, attribute revenue to a preinstall partner using the identified partner attribution identifier.

In this example, the revenue attribution system 104 may receive advertising revenue information (e.g., from advertising revenue information generated by the advertising analytics system) identifying a user device 110 that triggered a compensation event (e.g., a user device 110 displaying an advertisement 150, a user of the user device 110 engaging with the advertisement 150, or some other revenue generating function). The advertising revenue information may include a device identifier of the user device 110. Thereafter, the revenue attribution module 128 may retrieve a partner attribution identifier based on the device identifier from the advertising revenue information and identify an appropriate preinstall partner based on the partner attribution identifier. As a result, the revenue attribution module 128 may attribute a portion of revenue to be provided to the preinstall partner.

The optional security module 122 may receive a security identifier from the user device 110 and authenticate a security identifier. In some implementations, a preinstall partner may preinstall an application, a partner attribution identifier, and at least one security identifier on the user device 110. The user device 110 may provide the partner attribution identifier and the security identifier to the revenue attribution system 104 or the search system 108 at any time (e.g., within query wrapper and/or the search query 148 received from the search application 146).

The optional security module 122 may authenticate the security identifier in any number of ways. For example, the security identifier may be an encryption key, include an encrypted file, or the like. The optional security module 122 may retrieve security information based on the partner attribution identifier and utilize the security information (e.g., decrypt the security identifier to confirm authenticity) to authenticate the security identifier.

In various embodiments, the preinstall system 102 or other device may generate the security identifier or other token prior to preinstallation. For example, the security identifier may be a digital certificate, an encryption key, or any other security object that may be utilized for authentication. The security identifier may be stored in the attribution file (e.g., the attribution file 216 of FIG. 2). The preinstall system 102 may provide the attribution file including the partner attribution identifier and the security identifier to a partner device of a preinstall partner for preinstallation (e.g., as a part of a stock ROM).

It will be appreciated that the optional security module 122 may authenticate the security identifier (thereby authenticating the partner attribution identifier) in any number of ways. For example, the optional security module 122 may retrieve information, such as an encryption key, from the partner attribution identifier data store 132 to authenticate the security identifier.

In various embodiments, if authentication fails, the revenue attribution system 104 may not attribute revenue to the preinstall partner identified in the partner attribution identifier associated with the security identifier. The revenue attribution system 104 may, in some implementations, notify the preinstall partner identified by the partner attribution identifier if the security identifier is not authenticated. In some embodiments, the revenue attribution system 104 may request additional information from the user device 110 to confirm authenticity before attributing revenue to the preinstall partner identified by the partner attribution identifier.

If authentication succeeds, the revenue attribution system 104 may attribute a portion of the revenue and/or share revenue with the identified preinstall partner.

The advertisement network management module 124 receives advertisement identifiers from the advertisement system 106, the search system 108, the advertising analytics system, and/or advertisement networks. An advertisement identifier, as discussed herein, may identify an advertisement 150 to be displayed on the user device 110. In some implementations, the advertisement system 106 selects an advertisement 150 to display on the user device 110. The advertisement system 106 may provide the advertisement 150 or advertisement information such as advertisement linking information (e.g., a URL to an advertisement 150) to the user device 110. The advertisement system 106 may provide the advertisement identifier to the advertisement network management module 124 when the advertisement system 106 selects and/or provides the advertisement 150 to be displayed on the user device 110. Alternatively, or additionally, the search system 108 may receive the advertisement 150 or advertisement linking information. The search system 108 may provide the advertisement identifier to the advertisement network management module 124 of the revenue attribution system 104.

In some embodiments, the user device 110 (e.g., the search application 146 included on the user device 110), the advertising analytics system, and/or an advertisement network may provide the advertisement identifier to the advertisement network management module 124. The advertisement identifier may be provided to the advertisement network management module 124 in any number of ways.

The advertisement network management module 124 and/or the partner attribution identifier module 120 may associate the partner attribution identifier received from the user device 110 with the advertisement identifier that identifies the advertisement 150 to be displayed (or already displayed) on the user device 110. The partner attribution identifier, the advertisement identifier, and/or the association between the partner attribution identifier and the advertisement identifier may be stored in the partner attribution identifier data store 132 by the partner attribution identifier module 120 and/or the advertisement network management module 124.

The partner identification module 126 may identify a preinstall partner to attribute and share revenue. In various embodiments, the partner identification module 126 receives an indication that revenue has been generated (e.g., a compensation event has occurred) and an indication of an advertisement identifier that identifies an advertisement 150 that generated the revenue. For example, the partner identification module 126 may receive advertising revenue information from the advertising analytics system or any other device(s). The advertising revenue information may identify an amount of the revenue generated by the compensation event as well as the advertisement identifier that identifies the advertisement 150 that generated the revenue.

The partner identification module 126 may utilize the advertisement identifier from the advertising revenue information to identify a partner attribution identifier based on an association between the partner attribution identifier and the advertisement identifier stored in the partner attribution identifier data store 132. The revenue attribution module 128 may attribute a portion of the revenue identified in the advertising revenue information to a preinstall partner identified by the partner attribution identifier.

In some embodiments, the revenue attribution module 128 may attribute different portions of the revenue based on the preinstall partner identified by the partner attribution identifier and/or based on a type of the compensation event that has occurred to generate the revenue. In some implementations, the revenue attribution module 128 may retrieve one or more revenue rules based on the preinstall partner identified by the partner attribution identifier, the type of compensation event that has occurred, the partner attribution identifier, the advertisement 150, and/or any other information. The revenue rules may be stored in the revenue rules data store 134.

The revenue rules may identify a percentage or amount of revenue to provide to any number of preinstall partners. In some embodiments, different preinstall partners may agree to preinstall one or more applications in exchange for different percentages or amounts of advertising revenue generated using the applications. In some implementations, a percentage or amount of revenue to be shared may depend on an advertisement 150 (e.g., identified by an advertisement identifier) and/or a type of compensation event that occurs (e.g., an impression, a click-through, or satisfaction of a call to action, such as a registration or purchase) to generate the revenue. The revenue rules may identify a percentage or amount of revenue to be shared for any preinstall partners. The revenue rules may also identify a default percentage or amount of revenue to be shared for a preinstall partner that does not have any specific revenue rules that identify that preinstall partner for attribution of revenue thereto.

The revenue attribution module 128 may retrieve any number of revenue rules from the revenue rules data store 134 based on the partner attribution identifier, the advertisement identifier and/or the advertisement 150 associated with the revenue generation, the amount of the revenue, the type of compensation event that has occurred to generate the revenue, the preinstall partner identified by the partner attribution identifier, and/or any other information.

The revenue attribution module 128 may, in some embodiments, determine an amount of revenue to share with one or more preinstall partners based on a partner attribution identifier, one or more revenue rules, and/or any other information. In some embodiments, the revenue attribution module 128 generates a revenue report indicating at least one preinstall partner and an amount of revenue attributed to the preinstall partner (e.g., revenue generated from any number of compensation events). The revenue report may be provided to the preinstall partner or any other user or device. The revenue report may also include a partner attribution identifier, an advertisement identifier, one or more revenue rules, information from advertising revenue information, or any other information.

The optional compensation module 130 may direct revenue (e.g., payment) that is attributed by the revenue attribution module 128 to a preinstall partner. The optional compensation module 130 may direct payments to any number of preinstall partners. In some embodiments, a preinstall partner may receive a revenue report, payment, or both.

Although the partner attribution identifier is generally discussed as being associated with a single preinstall partner, in some embodiments, a partner attribution identifier may be associated with multiple preinstall partners or multiple entities. For example, a partner attribution identifier associated with multiple entities may be utilized to attribute revenue to the multiple entities.

In some embodiments, the revenue attribution system 104 may receive multiple partner attribution identifiers from a user device 110. In some implementations, the revenue attribution system 104 may attribute revenue to multiple preinstall partners, each preinstall partner associated with a different partner attribution identifier received from the user device 110. The division of revenue for each of the multiple of preinstall partners, for example, may be determined based on any number of revenue rules.

The partner attribution identifier data store 132 may include any number of partner attribution identifiers, advertisement identifiers, and/or associations between partner attribution identifier(s) and advertisement identifier(s). The partner attribution identifier data store 132 may, in some embodiments, store associations between partner attribution identifier(s) and any other information (e.g., associations between the partner attribution identifier(s) and user device identifier(s) of user device(s) 110). The partner attribution identifier data store 132 may include one or more databases, indices (e.g., inverted indices), files, or other data structures which may be used to implement the techniques of the present disclosure.

The revenue rules data store 134 may include any number of revenue rules. The revenue rules data store 134 may include one or more databases, indices (e.g., inverted indices), files, or other data structures which may be used to implement the techniques of the present disclosure.

The advertisement system 106 selects or generates advertisements 150 to be displayed on the user device 110. For example, the advertisement system 106 may generate and/or provide an advertisement 150 for a sponsored application. The advertisement system 106 transmits (e.g., serves) the advertisement 150 to the user device 110. The user device 110 may display the advertisement 150.

Although the disclosure describes generating revenue from advertisements 150 that are provided in search results from a search system 108, it will be appreciated that advertisements 150 may be provided to the user device 110 in any number of ways (e.g., in response to any request from an application stored in a stock ROM preinstalled by a preinstall partner on the user device 110).

For example, the advertisement system 106 may provide an advertisement 150 (e.g., advertising linking information including a URL to enable the user device 110 to access or retrieve the advertisement 150) for a sponsored application that is to be displayed on the user device 110 along with a list of applications included in search results. The advertisement 150 may include information indicating that the advertisement 150 (i.e., the sponsored application) is a sponsored result. For example, the advertisement 150 may include text indicating that the sponsored application is a “Sponsored Result” or an “Advertisement.”

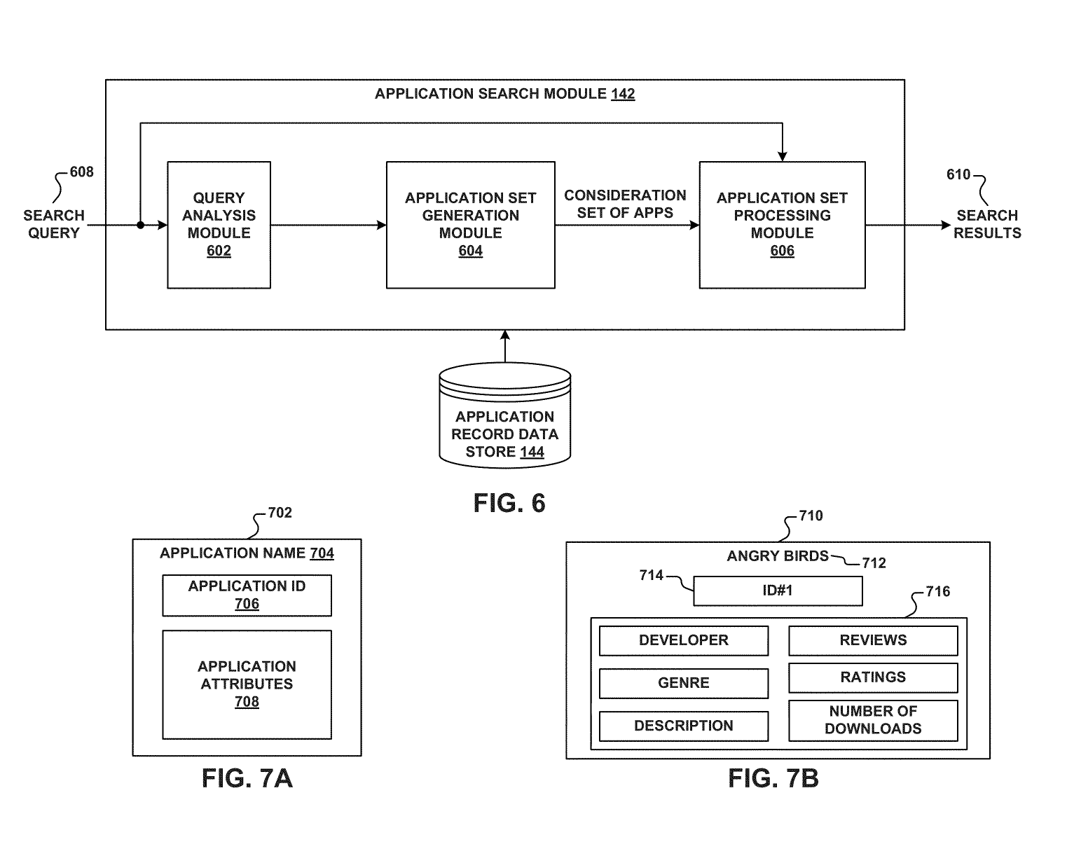

The search system 108 includes an application record data store 144 that may generate search results. The application record data store 144 may include data associated with one or more different applications. The data associated with an application may be referred to herein as an “application record” (e.g., the application record 702 of FIG. 7A). The application record data store 144 may include one or more such application records that each includes data related to a different application.

An application record may include a variety of different types of data related to an application. The application record may include, without limitation, a name of the application, a name of a developer of the application, a description of the application, one or more categories associated with the application, application statistics (e.g., a number of downloads of the application), keywords associated with the application, reviews associated with the application, platform(s) (e.g., one or more operating systems) and/or target device(s) of the application, a price of the application, and other information. The application record data store 144 may include data for a variety of different applications available on a variety of different operating systems and devices. The search system 108 may retrieve and analyze data from the application record data store 144 in order to provide search results.

In some examples, an application record associated with an application may include information that describes or otherwise indicates one or more of the following: 1) one or more functions associated with the application, 2) one or more internal states of the application (e.g., particular screen(s) or user interface(s) within the application), 3) application-related data (e.g., local business data used or provided by the application), 4) data from online sources (e.g., websites or blogs) related to the application, 5) a release date and/or an age of the application, and 6) trustworthiness of the application (e.g., whether the application is designated as “spam,” for example, based on a name of its developer).

The advertisement system 106 includes an advertisement data store 140 that the advertisement system 106 may use to store, generate, or provide advertisements 150. The advertisement data store 140 may include data associated with one or more different advertisements 150. The data associated with an advertisement 150 may be referred to as an “an advertisement record.” The advertisement data store 140 may include one or more advertisement records that each includes data for a different advertisement 150. The advertisement records may be generated by advertisers, by advertisement agencies, or by providers of any of the application search and advertisement generation functionalities described above (i.e., by providers of one or more of the search system 108 and the advertisement system 106), as some examples.

An advertisement record may include a variety of different types of data related to an advertisement 150. An advertisement record may include data that identifies the advertisement record. For example, the advertisement record may include an advertisement name and/or an advertisement identifier (ID) that identifies the advertisement record among the different advertisement records included in the advertisement data store 140.

An advertisement record may also include a sponsored application name and/or a sponsored application ID that identifies a sponsored application associated with the advertisement record. A sponsored application may be an application for which an advertiser has paid to have the application displayed to a user. For example, an advertiser may pay for a sponsored application to be advertised along with search results generated by the search system 108. The advertisement record may include advertisement content used to generate an advertisement 150 for the sponsored application of the advertisement record. For example, the advertisement content may include text, images (e.g., icons), animations, and videos associated with the sponsored application.

For example, the advertisement 150 (e.g., text and images) generated for the sponsored application may be displayed along with a list of applications included in search results on a user device 110. In some examples, the generated advertisement 150 may include a link that enables a user to purchase the sponsored application from one or more digital distribution platforms (e.g., app stores).

The advertisement record may also include advertisement parameters. The advertisement parameters may define one or more budgets associated with advertising the sponsored application. The advertisement parameters may also define one or more timing parameters associated with advertising the sponsored application, such as start and stop dates for advertising the sponsored application and/or time(s) of day during which the sponsored application is to be advertised, as some examples. Additionally, the advertisement parameters may specify user parameters associated with advertising the sponsored application, such as, for example, one or more search query languages for which the sponsored application is to be advertised and/or a number of times a particular advertisement 150 is to be displayed to each user.

The advertisement parameters may also include a variety of different types of targeting parameters. A targeting parameter may refer to a condition that should be satisfied before the advertisement system 106 generates an advertisement 150. The advertisement system 106 may use one or more targeting parameters included in an advertisement record to determine whether to generate an advertisement 150 for a sponsored application of the advertisement record. For example, the advertisement system 106 may generate an advertisement 150 for a sponsored application listed in an advertisement record when one or more targeting parameters of the advertisement record are satisfied. Example types of targeting parameters may include, but are not limited to, keyword targeting parameters and platform targeting parameters.

Additional advertisement (e.g., target) parameters may include, for example, time-slotting, day-parting, category, geographical, contextual, demographic, behavioral, platform, device, and partner parameters. In other words, in some examples, the advertisement system 106 may generate an advertisement 150 for a sponsored application in one or more of the following instances: 1) during one or more designated time slots, 2) on one or more given days or during one or more specified portions thereof, 3) for one or more particular categories of applications included in search results, 4) for users located in one or more geographic locations or regions, 5) based on context (e.g., for one or more states of a user's computing device, the search system 108, and/or the advertisement system 106), 6) for one or more specified user types or groups, 7) when one or more user behaviors are detected (e.g., when a user interacts with the user's computing device in a particular manner), 8) for one or more platform (e.g., operating system) and device types associated with a user's computing device or applications included in search results, and 9) when one or more specified partner computing systems are used (e.g., when a user's computing device communicates with the search system 108 and/or the advertisement system 106 via a designated partner device).

An advertisement record may include a targeting parameter function. A targeting parameter function may define which of one or more targeting parameters of the advertisement record should be satisfied in order to generate an advertisement 150. In some examples, the targeting parameter function may include a single targeting parameter. In these examples, the advertisement system 106 may generate an advertisement 150 for a sponsored application based on satisfaction of the single targeting parameter, such as a keyword targeting parameter. In other examples, the targeting parameter function may include multiple different targeting parameters. In these examples, the advertisement system 106 may generate an advertisement 150 for a sponsored application based on satisfaction of the multiple targeting parameters, such as a keyword targeting parameter and a platform targeting parameter. In scenarios where a targeting parameter function includes multiple targeting parameters, the targeting parameter function may include a Boolean function that includes the multiple targeting parameters.

The search system 108 is configured to receive search queries 148 from the user device 110 via the network 112. The search system 108 performs a search for applications in response to a received search query 148. The search system 108 may generate a set of search results that includes a list of applications, each of which is associated with a result score that indicates a rank of the application relative to the other applications in the list. The search system 108 may then transmit the search results to the user device 110 that transmitted the search query 148.

The user device 110 may display the search results to a user of the user device 110 and allow the user to select one or more of the applications in the list in order to view information related to the applications and/or download the applications. The applications (e.g., executable programs, or software) listed in the search results sent to the user device 110 may be accessible (e.g., downloadable) from systems different than the search system 108. Put another way, the search system 108 may store data related to applications that are accessible in locations other than the search system 108. For example, the applications may be accessible from digital distribution platforms configured to distribute the applications. Example digital distribution platforms include, but are not limited to, GOOGLE PLAY®, the APP STORE® developed by Apple Inc., and WINDOWS PHONE STORE® developed by Microsoft Corporation. Although the applications listed in the search results may be accessed in locations other than the search system 108, the search system 108 may include applications that are available for download in some examples.

The advertisement system 106 may use the search results generated by the search system 108 to generate advertisements 150. For example, the advertisement system 106 may transmit (e.g., serve) an advertisement 150 for a sponsored application to the user device 110 that generated the search query 148 so that the user device 110 may display the advertisement 150 along with the set of search results. The user may interact with the advertisement 150 on the user device 110. For example, the user may tap or click the advertisement 150 to download the sponsored application. In some examples, the user may tap the advertisement 150 to be directed to a digital distribution platform that provides the sponsored application for download.

In general, the generated advertisement 150 for the sponsored application may be presented to the user via the user device 110 in any of the following forms: 1) as part of a list of one or more applications that are similar to one or more applications included in the search results, 2) as one or more additional or complementary applications relative to one or more applications included in the search results (i.e., as one or more so-called “cross-sells”), 3) as one or more applications that are considered to provide improved functionality relative to one or more applications included in the search results (i.e., as one or more so-called “up-sells”), and 4) as one or more applications specifically developed or customized for a platform of the user device 110 and/or the user device 110 itself.

In some examples, the advertisement system 106 may generate an advertisement 150 for a sponsored application that belongs to the same family of applications as one or more applications included in the list of applications generated by the search system 108 (i.e., the search results). For instance, the sponsored application and the one or more applications included in the search results may be different application versions, or editions, belonging to the same application family. In this example, the sponsored application may be an application version, or edition, that is more optimized for the platform of the user device 110 and/or the user device 110 itself relative to the one or more applications included in the search results. In this manner, by generating the advertisement 150, the advertisement system 106 may suggest the sponsored application as a potentially better option for the user of the user device 110 relative to the one or more applications included in the search results.

The search system 108 includes the application record data store 144 and an application search module 142. The application record data store 144 includes a variety of different types of data related to different applications. The application record data store 144 may include one or more databases, indices (e.g., inverted indices), files, or other data structures which may be used to implement the techniques of the present disclosure. As described herein, the data included in the application record data store 144 may include descriptions of applications, statistics related to applications (e.g., download numbers, review numbers, etc.), and other information. The application search module 142 receives a search query 148 from the user device 110 and generates search results based on the search query 148 and data included in the application record data store 144.

The advertisement system 106 includes the advertisement data store 140, a record generation module 136, and an advertisement generation module 138. As described herein, the advertisement data store 140 includes data related to one or more different advertisements. As also described herein, the data related to an advertisement may be referred to as an advertisement record. Accordingly, the advertisement data store 140 may include one or more advertisement records each corresponding to a different advertisement. The advertisement data store 140 may include one or more databases, indices (e.g., inverted indices), files, or other data structures which may be used to implement the techniques of the present disclosure.

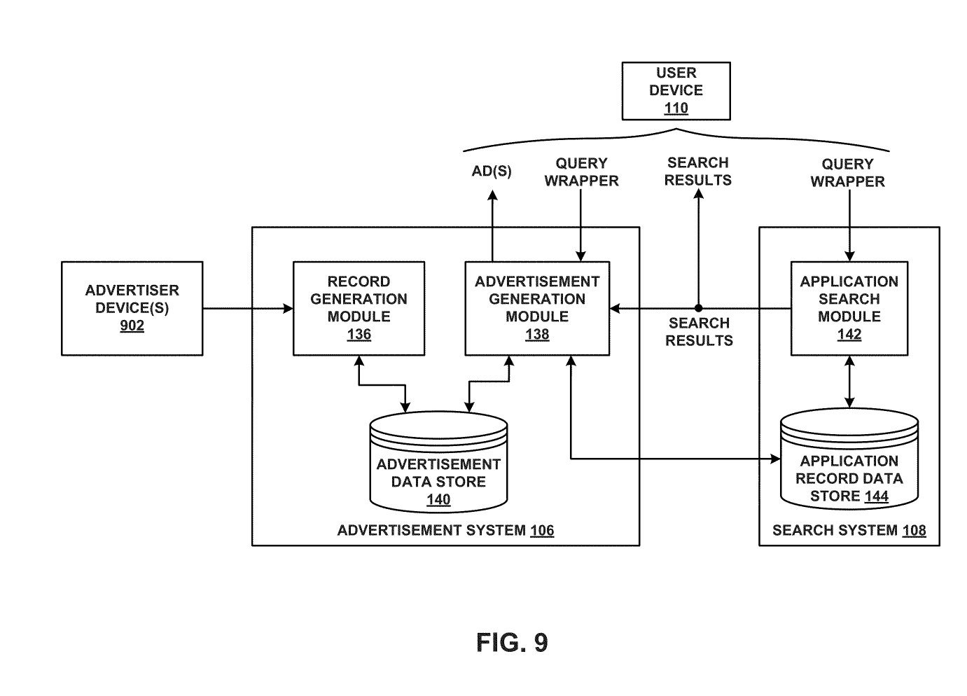

The record generation module 136 generates advertisement records included in the advertisement data store 140 based on data received from one or more advertiser device(s) (e.g., advertiser device(s) 902 of FIG. 9). The advertisement generation module 138 may generate advertisements 150 using data (i.e., advertisement records) from the advertisement data store 140. For example, the advertisement generation module 138 may identify an advertisement record based on satisfaction of a targeting parameter function included in the advertisement record. The targeting parameter function may be satisfied when targeting parameters of the targeting parameter function and/or a logical relationship (e.g., a Boolean function) specified by the targeting parameter function are satisfied. The advertisement generation module 138 may then generate an advertisement 150 based on data included in the identified advertisement record. The advertisement generation module 138 may transmit (e.g., serve) the generated advertisement 150 to the user device 110 that provided the search query 148.

The search system 108 and the advertisement system 106 may communicate with the user device 110 and the advertiser device(s) (e.g., advertisement networks) via the network 112. The user device 110 can be any computing device (i.e., a digital device with a processor and memory). In one example, the user device 110 is capable of providing search queries 148 to the search system 108 and receiving search results that are responsive to the search queries 148 from the search system 108. The user device 110 may include, but is not limited to, smartphones, tablet computers, laptop computers, and desktop computers. The user device 110 may also include other computing devices having other form factors, such as computing devices included in vehicles, gaming devices, televisions, or other appliances (e.g., networked home automation devices).

The user device 110 may use a variety of different operating systems. In an example where the user device 110 is a mobile device, the user device 110 may run an operating system including, but not limited to, ANDROID® developed by Google Inc., IOS® developed by Apple Inc., or WINDOWS PHONE® developed by Microsoft Corporation. In an example where the user device 110 is a laptop or desktop computing device, the user device 110 may run an operating system including, but not limited to, MICROSOFT WINDOWS® developed by Microsoft Corporation, MAC OS® developed by Apple Inc., or LINUX® (LINUX® is the registered trademark of Linus Torvalds in the U.S. and other countries). The user device 110 may also access the search system 108 while running operating systems other than the operating systems described above, whether presently available or developed in the future.

The user device 110 can communicate with the search system 108 via the network 112. In some examples, the user device 110 may communicate with the search system 108 using an application installed on the user device 110. In general, the user device 110 may communicate with the search system 108 using any application that can transmit search queries 148 to the search system 108. In some examples, the user device 110 may run an application that is dedicated to interfacing with the search system 108, such as an application dedicated to application searches. In other examples, the user device 110 may communicate with the search system 108 using a more general application, such as a web-browser application. In any case, the application may display a search field on a graphical user interface (GUI) into which a user may enter search queries 148. The user may enter a search query 148 using a touchscreen or physical keyboard, a speech-to-text program, or other form of user input.

A search query 148 entered into the GUI on the user device 110 may include words, numbers, and/or symbols. In general, a search query 148 may be a request for information retrieval (e.g., search results) from the search system 108. For example, a search query 148 may be directed to retrieving a list of applications (e.g., application names) in implementations where the search system 108 is configured to generate a list of applications (e.g., application names) as search results. A search query 148 directed to retrieving a list of applications in this manner may indicate a user's desire to retrieve applications that have a functionality implicated by the search query 148.

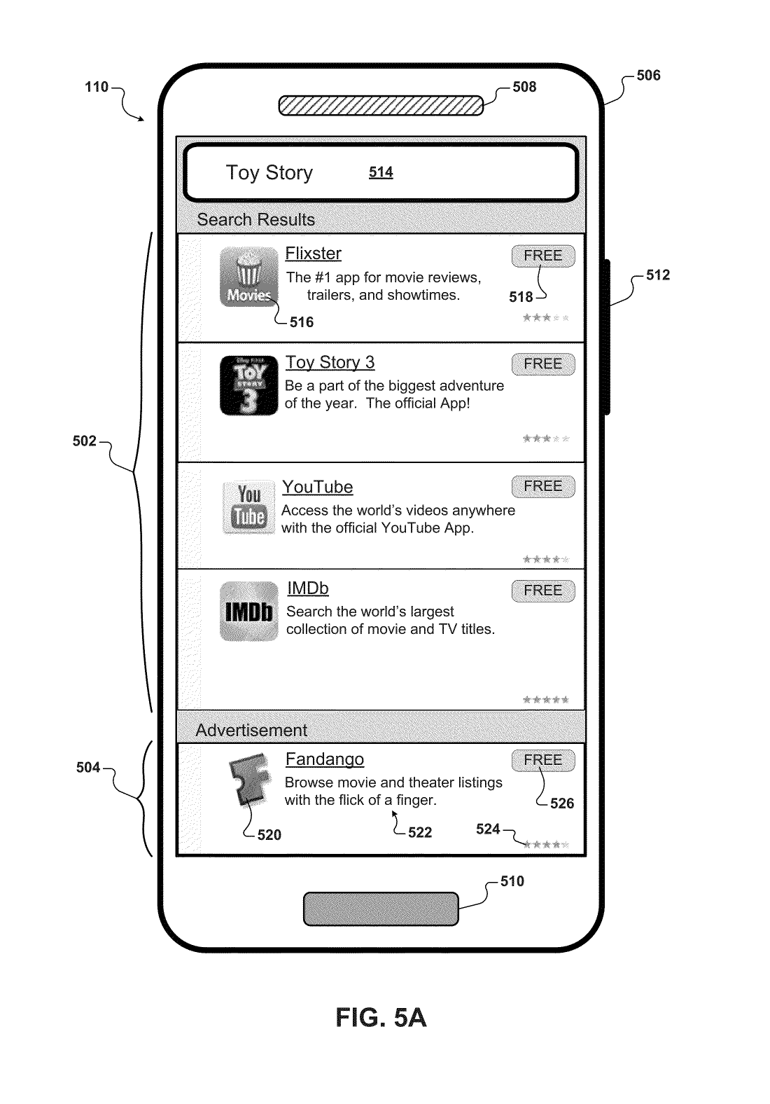

The user device 110 may receive a set of search results from the search system 108 that are responsive to the search query 148 transmitted by the user device 110 to the search system 108. The user device 110 may display the search results via the GUI. The application running on the user device 110 may display the search results in the GUI in a variety of different manners, depending on what information is transmitted to the user device 110. In examples where the search results include a list of ranked applications, the search system 108 may transmit the list of ranked applications to the user device 110. In this example, the GUI may display the search results to the user as a list of application names of the applications, e.g., arranged in the order of the ranked applications. In some examples, the search system 108, or other computing system, may transmit additional information to the user device 110 including, but not limited to, application ratings, application download statistics, application screenshots, and application descriptions. In these examples, the GUI may display this additional information along with the list of application names. In some examples, the GUI may display the search results as a list of application names ordered from the top of a screen of the user device 110 to the bottom of the screen, such that the list of application names is ordered by descending result scores. In other examples, the search results may be displayed under the search field into which the user entered the search query 148. An example GUI including search results and a generated advertisement 150 is illustrated and described herein with respect to FIG. 5A.

In some examples, the user device 110 may communicate with the search system 108 and the advertisement system 106 via a partner computing system (not shown in FIG. 1). The partner computing system may be a computing system of a third party that may leverage the search functionality of the search system 108 and the advertising functionality of the advertisement system 106. The partner computing system may belong to a company or organization other than that which operates the search system 108 and/or the advertisement system 106. Example third parties which may leverage the functionality of the search system 108 and the advertisement system 106 may include, but are not limited to, internet search providers and wireless communications service providers. The user device 110 may send search queries 148 to the search system 108 and receive search results via the partner computing system. The user device 110 may also receive advertisements 150 from the advertisement system 106 via the partner computing system. The partner computing system may provide a user interface to the user device 110 in some examples and/or modify the search experience provided on the user device 110.

The search system 108 may use data from data sources (not shown in FIG. 1) to update one or more databases, indices, files, or other data structures included in the application record data store 144. The data sources may be any sources of data which the search system 108 may use to generate and update the application record data store 144. The search system 108 may generate new application records (e.g., the application record 702 of FIG. 7A) and update existing application records based on data retrieved from the data sources. Although not illustrated in FIG. 1, the search system 108 may include modules that generate new application records and update existing application records based on the data retrieved from the data sources. In some examples, some data included in the application record data store 144 may be manually generated.

The data sources may include a variety of different data providers. The data sources may include data from application developers, such as application developers' websites. The data sources may include operators of digital distribution platforms configured to distribute applications to user devices 110. The data sources may also include other websites, such as websites that include web logs (i.e., blogs), application review websites, or other websites including data related to applications. Additionally, the data sources may include social networking sites, such as “FACEBOOK®” by Facebook, Inc. (e.g., Facebook posts) and “TWITTER®” by Twitter Inc. (e.g., text from tweets). The data sources may also include additional types of data sources in addition to the data sources described above. Different data sources may have their own content and update rate.

The search system 108 retrieves data from one or more of the data sources. The data retrieved from the data sources can include any type of data related to applications. Examples of data related to applications include, but are not limited to, a name of an application, a description of an application, a substantive review of an application, a quality rating of an application, a developer name, an excerpt from a blog post about an application, a tweet about an application, and one or more images (e.g., icons and/or screenshots) associated with the application. The search system 108 may also retrieve statistical data from the data sources. The statistical data may include any numerical data related to an application, such as a number of downloads, download rates (e.g., downloads per month), a number of reviews, and a number of ratings. In some examples, the data retrieved from the data sources may include information regarding the functionalities of applications.

A module, as described herein, is any hardware, software, or combination of hardware and software. Although each system described herein depicts one or more modules, it will be appreciated that any such module may perform more or less functionality than what is described herein. Further, each system described herein may have any number of modules, processors, digital devices, or the like.

FIG. 2 illustrates an example user device 110 with a stock ROM 208 including a search application 212 and a partner attribution identifier 218 in some embodiments. In various embodiments, an attribution file 216 (including the partner attribution identifier 218) also included in the stock ROM 208 is stored in a memory (i.e., the memory component(s) 202) of the user device 110, such that the attribution file 216 may not be overrun, modified, or deleted when the search application 212 is updated, modified, or removed. As a result, in some implementations, regardless of what happens to the search application 212, the attribution file 216 (and thus the partner attribution identifier 218) may not be touched or otherwise impacted and a partner identified by the partner attribution identifier 218 will not lose attribution of revenue, as described herein.

Although the user device 110 of FIG. 2 is depicted as a smartphone, the user device 110 maybe any digital device as described herein. As shown in FIG. 2, the user device 110 includes memory component(s) 202, processing unit(s) 204, and input/output (I/O) component(s) 206. The memory component(s) 202 may include any non-transitory memory configured to store data. The memory component(s) 202 may, for example, include storage devices such as random access memory (RAM) (e.g., synchronous dynamic RAM (SDRAM), or any other kind of RAM), read-only memory, a cache, and flash memory (e.g., NOR flash and/or NAND flash memory). The memory component(s) 202 may include external memory as well, such as, for example, microSD card memory.

The processing unit(s) 204 may include any number of data processing devices (e.g., processor(s)) including, for example, one or more central processing units (CPUs) such as a multicore CPU, graphics processing unit(s) (GPUs), and/or digital signal processor(s) (DSPs). The processing unit(s) 204 may be configured to execute executable instructions (e.g., programs stored on the memory component(s) 202 such as the search application 212 and/or one or more additional applications 214 also included in the stock ROM 208). In some examples, the processing unit(s) 204 include circuitry or any data processing device capable of processing the executable instructions.

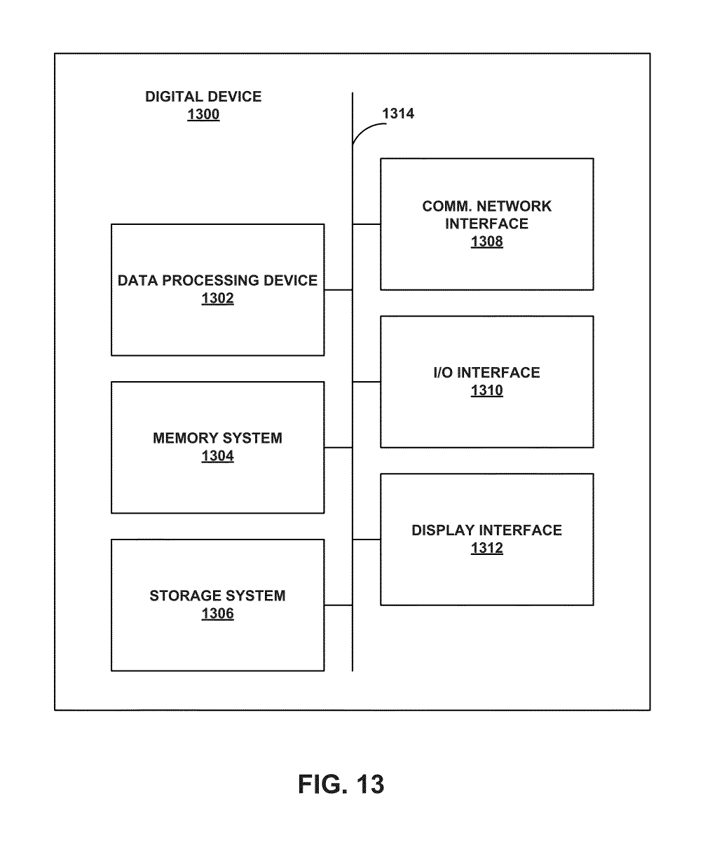

The I/O component(s) 206 may include any number of components that support communication between the user device 110 and a user of the user device 110. The I/O component(s) 206 may include components that support capacitive touch screens, keyboards, styluses, mice, gestures, displays, or the like. The I/O component(s) 206 may include similar functionality as described regarding the I/O interface 1312 of the digital device 1300 described herein with reference to FIG. 13.

As described herein, the stock ROM 208 may be stored in the memory component(s) 202 (e.g., in flash memory or another memory component). The stock ROM 208 may include an operating system 210, the search application 212, the additional application(s) 214, and the attribution file 216. The attribution file 216 may include the partner attribution identifier 218 and additional information 220. Although the phrase “stock ROM” is used with respect to FIG. 2, it will be appreciated that the stock ROM 208 depicted in FIG. 2 may be a factory image (i.e., a subclass of a ROM) or an “operating system image.”

The stock ROM 208 may be a “factory ROM” image that is pre-installed on the user device 110 or may be downloaded “Over the Air” (OTA) by a carrier or original equipment manufacturer (OEM), e.g., to the user device 110. For example, the stock ROM 208 may be an ANDROID® ROM, which is a file containing executable instructions (e.g., a system image) of the ANDROID® operating system and affiliated applications. In some embodiments, the stock ROM 208 may or may not have some set of ANDROID® application packages (.apks) pre-installed (i.e., included in the stock ROM 208). A custom ROM may be from a third party. For example, the custom ROM may be a uniquely modified operating system, or a stock version made available before vendor releases for a model of a user device 110. In some examples, the custom ROM may include all, some, or none of the ANDROID® application packages (.apks) included in the stock ROM 208. In other examples, a particular application (e.g., an .apk) may be present in all ROMs for a given operating system. For instance, the “Settings” application available on devices using the ANDROID® operating system may always be present in ANDROID® ROMs, be they custom or from the factory, though the “Settings” application is still packaged using an .apk. The stock ROM 208 may, in some embodiments, be compressed. If compressed, the stock ROM 208 may be decompressed when the user device 110 is first turned on (e.g., activated for the first time) and/or when a user performs one or more “factory default reset” actions that revert the user device 110 to default settings. For example, the user may purchase the user device 110 and may activate the user device 110 upon which the stock ROM 208 may be decompressed. In some embodiments, the stock ROM 208 is decompressed at a factory that made all or a part of the user device 110 before the user device 110 is placed in retail packaging. The determination when the stock ROM 208 may be decompressed may be based on decisions of a device manufacturer, original equipment manufacturer (OEM), and/or carrier associated with the user device 110.

In some embodiments, in order to install the stock ROM 208 on the user device 110, a byte-for-byte copy of an image of the stock ROM 208 may be stored in an appropriate storage medium (e.g., flash memory in the memory component(s) 202) at an appropriate storage location (e.g., the exact storage method may be user device 110- and/or manufacturer-specific).

The attribution file 216 may reside in a “read-only” directory. This means that overwriting the attribution file 216 may be restricted to a root user or restricted to a partner that built the stock ROM 208. A native application such as the search application 212 may not have permission to write to the directory including the attribution file 216.

In some embodiments, the operating system 210, applications (e.g., the search application 212 and/or the additional application(s) 214), and the attribution file 216 included in the stock ROM 208 may not be modified/removed by the user of the user device 110. In some implementations, for example, the user may not remove, modify, or change the attribution file 216 of the user device 110 unless the user uses a root account (e.g., a superuser account, a root account, or an administrator account) to modify, remove, or otherwise change the operating system 210, the applications (e.g., the search application 212 and/or the additional application(s) 214), and/or the attribution file 216. In this manner, the attribution file 216 may be present for the life of the user device 110. Accordingly, the attribution file 216 may stay persistent in the user device 110 so that a partner identified by the partner attribution identifier 218 stands an improved chance of not losing revenue attribution over time (e.g., over the life of the user device 110).

In various embodiments, the user device 110 may include a default partner identifier. For example, there may be a default partner identifier stored in an “assets” directory of an .apk build. The process of identifying the default partner identifier is further discussed herein. In various embodiments, when the partner attribution identifier 218 is unavailable or is corrupt, the search application 212 may retrieve the default partner identifier and/or generate an error notification (e.g., an error message).

The operating system 210 may be any operating system that manages computer hardware and software resources. For example, the operating system 210 may include, but is not limited to, ANDROID® developed by Google Inc., TIZEN® developed by Linux Foundation, IOS® developed by Apple Inc., or WINDOWS PHONE® developed by Microsoft Corporation. In an example where the user device 110 is a laptop or desktop computing device, the operating system 210 may include, but is not limited to, MICROSOFT WINDOWS® developed by Microsoft Corporation, MAC OS® developed by Apple Inc., or LINUX® (LINUX® is the registered trademark of Linus Torvalds in the U.S. and other countries).

As discussed herein, an application, such as the search application 212, may be included in the stock ROM 208. In this example, the search application 212 may include or have functions similar to the search application 146 discussed regarding FIG. 1. In various embodiments, the application (e.g., the search application 212) may assist in receiving and/or displaying of advertisements 150 and providing all or part of the attribution file 216 (e.g., the partner attribution identifier 218) to a revenue attribution system 104 or any other digital device. Although the stock ROM 208 depicts the search application 212, it will be apparent that any application provided by an application developer (e.g., received from the preinstall system 102) may be included in the stock ROM 208.

The additional application(s) 214 may include any number of different applications including, for example, other applications initially provided to a preinstall partner from the preinstall system 102. The additional application(s) 214 may include other applications from a manufacturer, an OEM, a carrier, a reseller, or any application developer.

As shown in FIG. 2, the attribution file 216 may include the partner attribution identifier 218 and the additional information 220. The partner attribution identifier 218 may be configured to perform the function of the partner attribution identifier discussed herein. For example, the partner attribution identifier 218 may identify a preinstall partner that included the application (e.g., the search application 212) in the stock ROM 208 or any entity associated with the decision to include the application (e.g., the search application 212) in the stock ROM 208 that is to receive attribution of revenue as discussed herein.

The additional information 220 may include any or no additional information. In some implementations, the additional information 220 included in the attribution file 216 may include a security identifier as discussed herein and/or one or more analytics tokens. The security identifier may be utilized by a system (e.g., the revenue attribution system 104 or the search system 108) to ensure that an API call belongs to a particular preinstall partner. For example, the security identifier may be used to authenticate or otherwise confirm the accuracy of a message (e.g., that the message has not been tampered with), a source of the message, and/or a recipient of the message. The security identifier may, for example, be an encrypted message (e.g., a digital signature), encryption key, challenge request, challenge response, or the like.

In one example, the security identifier included in the additional information 220 may be included in a query wrapper that is provided from the search application 212 to the search system 108 and/or the revenue attribution system 104. The search system 108 and/or the revenue attribution system 104 may authenticate, decrypt, decompress, and/or perform other security measures using the security identifier. If the security identifier is not correct or is absent, the search system 108 and/or the revenue attribution system 104 may deny requests and/or notify users and/or devices of the requests.

The analytics tokens included in the additional information 220 may be used for analytical services. For example, the additional information 220 may include one or more analytics tokens that provide or assist in providing aggregate statistics as to how an application (e.g., the search application 212) functions or is used. Example analytics tokens may include tokens for GOOGLE ANALYTICS and MIXPANEL. GOOGLE ANALYTICS and MIXPANEL provide information about how often some/each portion of on-device software is accessed. Worded another way, these services may collect user interaction data from all installed instances of one or more native applications such as the search application 212.

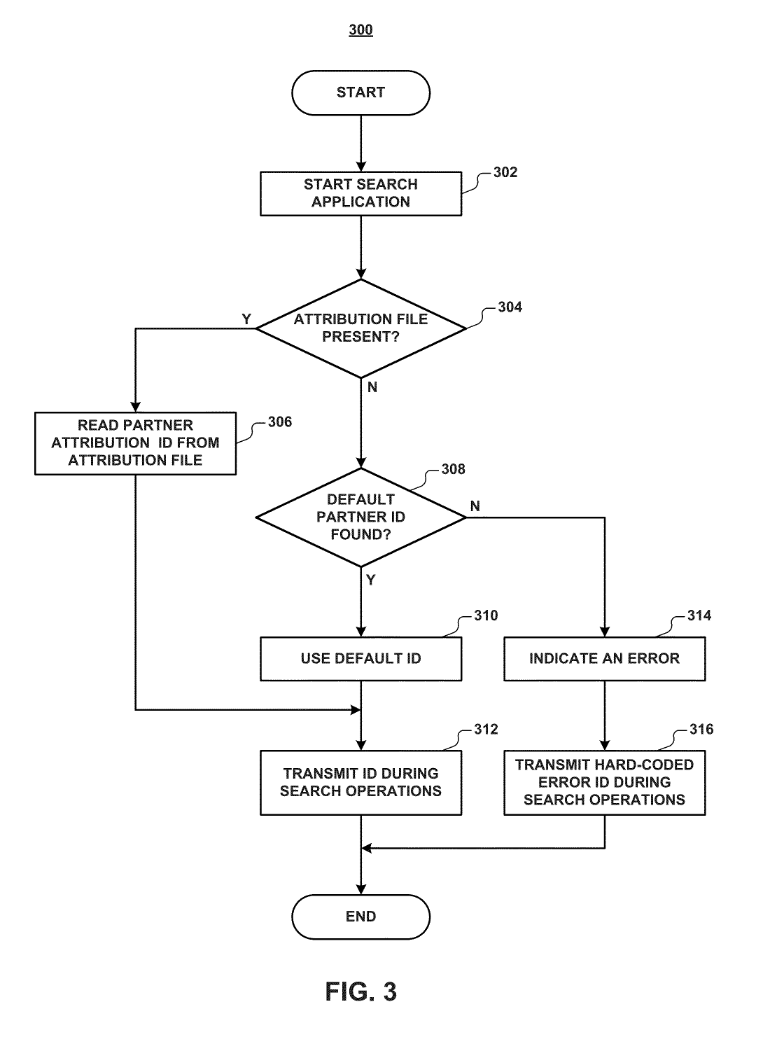

FIG. 3 illustrates an example method 300 performed by a user device 110 to identify and provide a partner attribution identifier to a device, such as the revenue attribution system 104, the advertisement system 106, or the search system 108 in some embodiments. In various embodiments, an application developer configures the search application 146 to look for an attribution file (e.g., the attribution file 216 of FIG. 2) and/or a partner attribution identifier (e.g., the partner attribution identifier 218 of FIG. 2) included therein. In one example, the search application 146 detects the attribution file and/or the partner attribution identifier upon startup and/or execution of the search application 146.

In step 302, the search application 146 is executed, or started. In step 304, the search application 146 detects or assists in detecting the presence of the attribution file and/or the partner attribution identifier included therein.

If the attribution file (and thus the partner attribution identifier included therein) exists or is present (“Y” in step 304), in step 306, the search application 146 reads the partner attribution identifier from the attribution file. In step 312, the search application 146 transmits the partner attribution identifier during search operations. For example, the search application 146 may include the partner attribution identifier for each API call made by the search application 146 to the search system 108 (e.g., with a query wrapper and/or a search query 148). The search application 146 may provide the partner attribution identifier read from the attribution file to the revenue attribution system 104, the advertisement system 106, or the search system 108 (e.g., as a part of a query wrapper and/or a search query 148).

If the search application 146 does not detect the presence of the attribution file or the partner attribution identifier (“N” in step 304), changes in operation of the search application 146 may not be observable by a user of the user device 110 during typical use of the search application 146. For example, the user could use the search application 146 to perform searches for applications in the same manner whether the attribution file or the partner attribution identifier is present or not.

If the search application 146 does not detect the attribution file or the partner attribution identifier (“N” in step 304), in step 308, the search application 146 may seek to detect or assist in detecting the presence of a default partner identifier. For example, the default partner identifier may be included within the search application 146, e.g., coded within an .apk for the search application 146. If the default partner identifier is detected or found (“Y” in step 308), in step 310, the search application 146 may use the default partner identifier instead of the partner attribution identifier in the manner described above. For example, the search application 146 may provide the default partner identifier to the revenue attribution system 104, the advertisement system 106, or the search system 108 (e.g., as a part of a query wrapper and/or a search query 148). In some embodiments, if the default partner identifier is detected, the user device 110 may notify one or more users, preinstall partners, advertisers, administrators, and/or others of the detection.

If the default partner identifier, which may be included in the search application 146, is not found (e.g., there is no attribution file, no partner attribution identifier in the attribution file, or no default partner identifier in the search application 146) (“N” in step 308), in step 314, the search application 146 provides an error indication. In some examples, the user of the search application 146 may view this error indication in a particular GUI or screen of the search application 146. (See, e.g., FIG. 5D). The error indication may indicate that the search application 146 and/or the user device 110 are corrupted. Accordingly, a person (e.g., the user, a developer of the search application 146, and/or a manufacturer of the user device 110) may determine whether the attribution file, the search application 146, and/or the user device 110 has a problem based on the error indication. The person could also determine the status or condition of the search application 146, the attribution file, and/or the user device 110 based on the error indication. In some examples, if the search application 146 does not identify the attribution file and/or the partner attribution identifier, and does not identify the default partner identifier, the search application 146 may provide the error indication to the revenue attribution system 104, the advertisement system 106, or the search system 108 and/or display an error message to the user. In an optional step 316, the search application 146 may further provide or transmit a hard-coded error identifier during search operations in such instances.

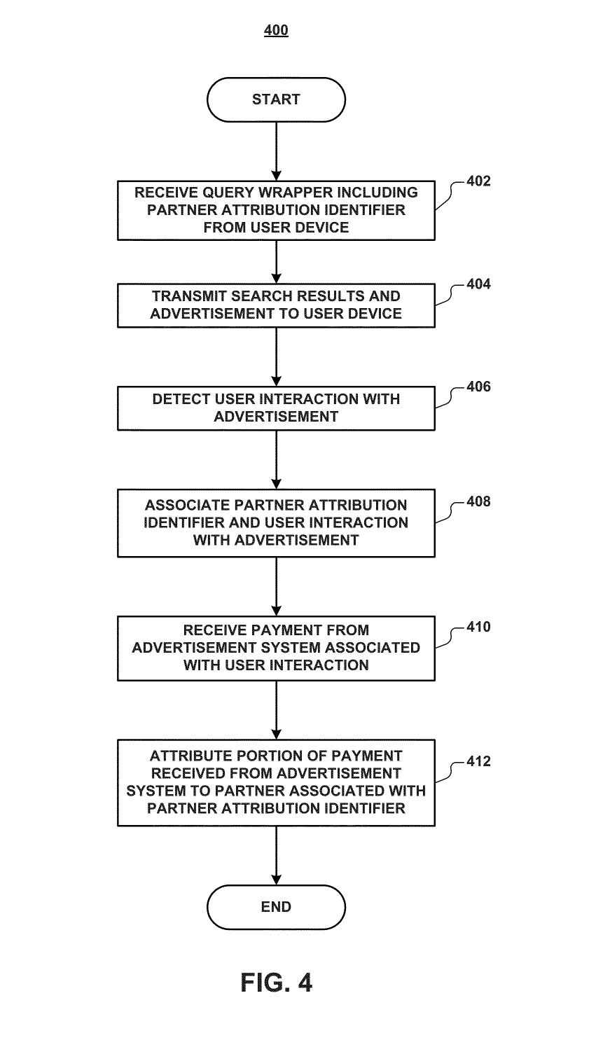

FIG. 4 illustrates an example method 400 for attributing a portion of revenue in some embodiments. In step 402, the search system 108 receives a query wrapper including a partner attribution identifier from the user device 110. The search system 108 may provide the partner attribution identifier to the revenue attribution system 104. In some embodiments, the search system 108 provides all or part of the query wrapper to the advertisement system 106. The advertisement system 106 may provide the partner attribution identifier to the revenue attribution system 104 in some examples.

In step 404, the search system 108 provides, or transmits, search results and an advertisement 150 to the user device 110. In some embodiments, the search system 108 determines the search results based on information from the query wrapper (e.g., a search query 148). The advertisement system 106 may identify the advertisement 150 in any number of ways including, for example, based on information from the query wrapper and/or the search results of the search system 108. In some examples, the advertisement system 106 may provide the advertisement 150 to the user device 110 or to the search system 108, which may then provide the advertisement 150 to the user device 110.

In various embodiments, the search system 108 or the advertisement system 106 may provide an advertisement identifier associated with the advertisement 150 to the revenue attribution system 104. The revenue attribution system 104 may associate the partner attribution identifier with the advertisement identifier. The advertisement identifier may specifically identify one or more advertisements, including the advertisement 150. In some embodiments, the advertisement identifier may identify a time (e.g., a timestamp) when an advertisement (e.g., the advertisement 150) was selected, served, or provided to the user device 110. In various embodiments, the advertisement identifier may be a session identifier associated with selection, serving, or transmitting of an advertisement (e.g., the advertisement 150). It will be appreciated that the advertisement identifier may identify or be related to the advertisement 150 (and to any number of other advertisements) displayed on the user device 110 in any number of ways.

The advertisement system 106 may, in some embodiments, provide advertisement codes (e.g., advertising linking information, such as one or more URLs) with the advertisement 150 provided to the user device 110 to enable an advertising analytics system to detect compensation events.

In step 406, the advertising analytics system detects user interaction with the advertisement 150. The user interaction may include any action including, for example, a user taking action to enable the advertisement 150 to be displayed to the user, the user clicking on the advertisement 150, and/or otherwise engaging with the advertisement 150 (e.g., registering or making a purchase).

In step 408, the revenue attribution system 104 associates the partner attribution identifier with the user interaction of the advertisement 150. For example, the advertising analytics system may provide advertising revenue information associated with the user interaction of the advertisement 150 to the revenue attribution system 104. The advertising analytics system may, for example, provide to the revenue attribution system 104 a report that includes the advertisement identifier associated with the advertisement 150, indication of revenue that was generated by the user interaction of the advertisement 150, and/or a type of compensation event applicable with respect to the advertisement 150. The revenue attribution system 104 may identify the previously received partner attribution identifier based on the advertisement identifier included in the received advertising revenue information.

In step 410, the revenue attribution system 104 receives payment, or revenue, from an advertisement system associated with the user interaction of the advertisement 150, e.g., the advertising analytics system, an advertisement network, or advertisers related to the compensation event. In step 412, the revenue attribution system 104 attributes a portion of the payment, or revenue, received from the advertisement system associated with the user interaction of the advertisement 150 (e.g., the advertising analytics system, the advertisement network, or the advertisers) to one or more preinstall partners associated with the partner attribution identifier that is identified using the advertisement identifier. The revenue attribution system 104 may determine the portion of the payment, or revenue, to be attributed (e.g., a value, a percentage, a threshold, or any other payment function) based on one or more revenue rules associated with the preinstall partner(s), the advertisement identifier, the compensation event, or the like.

In various embodiments, the revenue attribution system 104 may generate a report identifying the portion of the payment, or revenue, to be attributed to the preinstall partner(s) and/or provide the portion of the payment, or revenue, to the preinstall partner(s).

FIG. 5A is an illustration of an example GUI on a user device 110 that includes search results 502 and an example advertisement 504 in some embodiments. The advertisement 504 may include advertisement content from an advertisement record. The user device 110 may be a smartphone. The user device 110 includes a housing 506, a speaker 508, and mechanical buttons 510 and 512. A display of the user device 110 displays a GUI that includes a search field 514 that receives a search query 148 from a user of the user device 110. In FIG. 5A, the search query 148 (“Toy Story”) was entered by the user and transmitted to the search system 108.

The GUI displays the search results 502 generated by the search system 108 in response to receiving the search query 148. The search results 502 are listed below the search field 514. The search results 502 are labeled as “Search Results.” The search results 502 reference applications and include associated application icons (e.g., the icon 516), application names, application descriptions, application ratings, and download buttons (e.g., the button 518) for downloading the applications. In the example of FIG. 5A, the applications referenced by the search results 502 include “FLIXSTER®” by Flixster Inc., “TOY STORY® 3” by Disney Enterprises Inc., “YOUTUBE®” by Google Inc., and “IMDB®” by IMDb.com Inc. In some examples, the user may scroll down the display (e.g., a screen) of the user device 110 to view additional search results generated by the search system 108.

The GUI of FIG. 5A displays the example advertisement 504 that may be generated by the advertisement system 106. The example advertisement 504 is for a sponsored application named “FANDANGO®” by Fandango LLC. The example advertisement 504 for “FANDANGO®” is labeled as an “Advertisement.” The example advertisement 504 includes an application icon 520 that represents the sponsored application. The example advertisement 504 also includes a description 522, ratings 524, and a download button 526. The user may interact with the download button 526 (e.g., press the download button 526) in order to download the sponsored application or be directed to a digital distribution platform that provides the sponsored application for download.

FIGS. 5B-5D are images of an example search application 146 executing on a mobile device. Specifically, the images of FIGS. 5B-5D depict a process for determining if a partner attribution identifier or a default partner identifier is detected by the search application 146 in some embodiments. FIG. 5B depicts a mobile device (e.g., the user device 110) that has executed the search application 146. FIG. 5C depicts an image showing a menu of the search application 146 including “about,” “feedback,” and “settings” options provided by the search application 146. In various embodiments, a user of the mobile device may provide a gesture to the mobile device to access the menu.

FIG. 5D depicts an “about us” interface of the search application 146 accessible from the menu (e.g., by selecting the “about” option depicted in FIG. 5C). In the example of FIG. 5D, if a partner attribution identifier or a default partner identifier associated with the mobile device is found (e.g., in a memory or other storage device of the mobile device), the “about us” interface may not depict an error. In this example, once the user engages the “about” option of the menu shown in FIG. 5C, the search application 146 may attempt to detect the partner attribution identifier. If the partner attribution identifier is not detected, the search application 146 may attempt to detect the default partner identifier. In another example, if both the partner attribution identifier and the default partner identifier are not detected, the search application 146 may depict an error message (e.g., “Error: Partner/Default ID not found,” as shown in FIG. 5D). The search application 146 may also provide a notification of the error to the user (e.g., via the mobile device), the revenue attribution system 104, the advertisement system 106, the search system 108, and/or any other users or devices. In some embodiments, the search application 146 may depict an error message and/or notify other devices and users if a partner attribution identifier is not detected (e.g., even if the default partner identifier is detected).

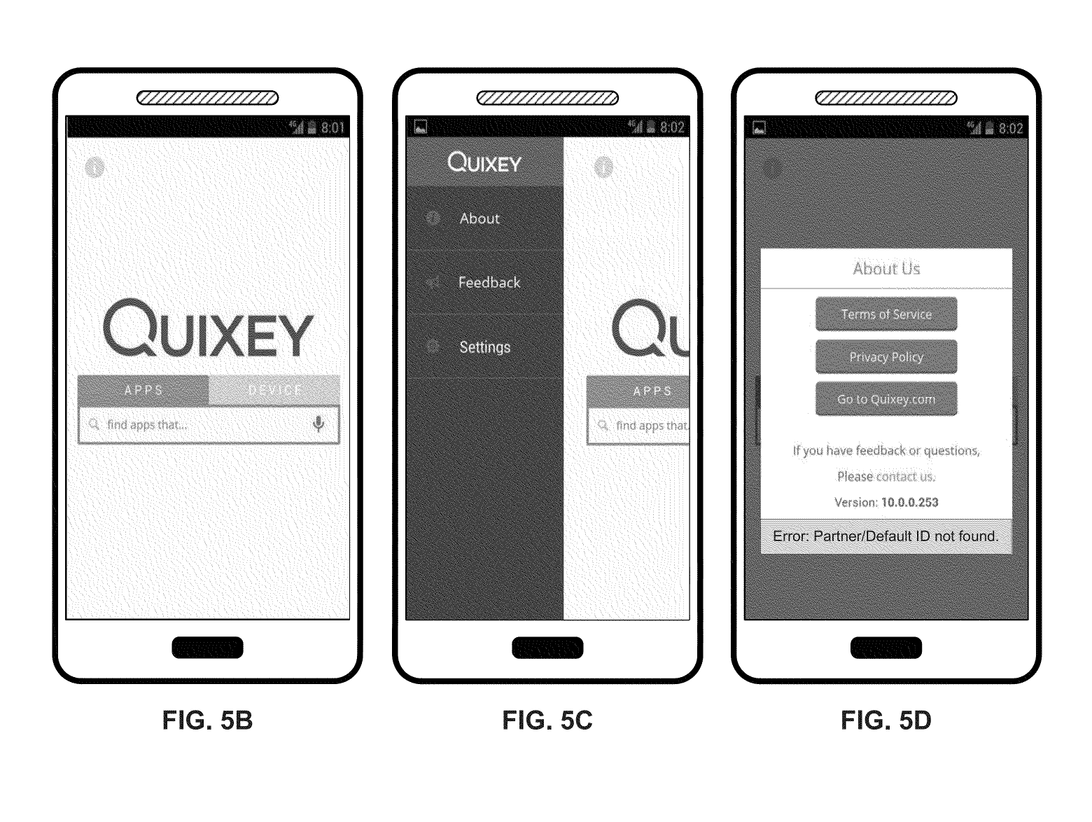

FIG. 6 shows an example application search module 142 that may be included in the search system 108 in some embodiments. The application search module 142 includes a query analysis module 602, an application set generation module 604 (hereinafter, “set generation module 604”), and an application set processing module 606 (hereinafter, “set processing module 606”). The query analysis module 602 analyzes a received search query 608 (e.g., the search query 148 of FIG. 1). The set generation module 604 identifies a set of application identifiers 706 of application records 702 (see FIG. 7A) representative of applications (i.e., identifies a set of applications) based on the received search query 608. The identified set of applications may be referred to herein as a “consideration set.” The set processing module 606 processes (e.g., scores) the consideration set to generate a set of search results 610 that may include a list of applications (e.g., application names) along with corresponding result scores.

As described above, the application record data store 144 includes data related to one or more different applications. As also described above, data associated with an application may be referred to herein as an “application record” (e.g., the application record 702 of FIG. 7A). Accordingly, as previously described, the application record data store 144 may include one or more different application records that each include data related to a different application. The application record 702 of FIG. 7A may be the same or different than the application records described herein.

FIGS. 7A-7B illustrate example application records 702 and 710, respectively, in some embodiments. Referring to FIG. 7A, the example application record 702 includes an application name 704, an application identifier (“ID”) 706, and application attributes 708. The application record 702 may generally represent data stored in the application record data store 144 that is related to an application. The application record data store 144 may include one or more application records each having a structure that is similar to that of the application record 702. Put another way, the application record data store 144 may include one or more application records each having an application name 704, an application ID 706, and application attributes 708.

The application name 704 may be a name of the application represented by the data included in the application record 702. Example application names may include “GOOGLE MAPS,” “FACEBOOK,” “TWITTER,” “MICROSOFT WORD,” or “ANGRY BIRDS.” The application ID 706 identifies the application record 702 among the other application records included in the application record data store 144. For example, the application ID 706 may uniquely identify the application record 702. The application ID 706 may be a string of alphabetic, numeric, and/or symbolic characters (e.g., punctuation marks) that uniquely identify the application record 702 in which the application ID 706 is included.

The application attributes 708 may include any type of data which may be associated with the application represented by the application record 702. The application attributes 708 may include a variety of different types of data. For example, the application attributes 708 may include structured, semi-structured, and/or unstructured data. The application attributes 708 may include information that is extracted or inferred from documents retrieved from the data sources described above with reference to FIG. 1. In some examples, the application attributes 708 may include data that is manually generated. The application attributes 708 may be updated so that up-to-date search results can be provided in response to a user search query 608.

The application attributes 708 may include a name of a developer of the application represented by the application record 702, a publisher of the application, a category (e.g., genre) of the application, a description of the application (e.g., a developer's description), a version of the application, the operating system for the application, and a price of the application. The application attributes 708 may also indicate security or privacy data about the application, battery usage of the application, and bandwidth usage of the application.

The application attributes 708 may include application statistics associated with the application represented by the application record 702. The application statistics may refer to numerical data related to the application. For example, the application statistics may include, but are not limited to, a number of downloads, a download rate (e.g., downloads per month), a number of ratings, and a number of reviews. The application attributes 708 may also include information retrieved from websites such as reviews associated with the application, articles associated with the application (e.g., wiki articles), or other information. The application attributes 708 may also include digital media related to the application, such as images (e.g., icons and/or screenshots).

FIG. 7B shows an example application record 710 for an application (e.g., a game) named “ANGRY BIRDS®” by Rovio Entertainment Limited. The application record 710 includes an application name “ANGRY BIRDS” indicated at 712. The application record 710 also includes an application ID (i.e., an ID number) “ID#1” indicated at 714. The application record 710 further includes application attributes 716. The application attributes 716 include data fields for a name of a developer and a genre of the application (i.e., ANGRY BIRDS®). For example, the developer of the application included in the application attributes 716 may be “ROVIO ENTERTAINMENT LIMITED.” The genre of the application may be “GAMES.” The application attributes 716 also include fields for a description and reviews related to the application. The description field may include text that describes ANGRY BIRDS®. In some examples, the description may be provided by the developer of the application. The field for the reviews may include text from user reviews for the application in some examples.

The application attributes 716 also include fields for application statistics, such as ratings and a number of downloads. The ratings field may indicate ratings given to the application by users. For example, the ratings may include a number of stars (e.g., 0-5 stars) assigned to the application by the users. The number of downloads field may indicate a total number of times the application has been downloaded.

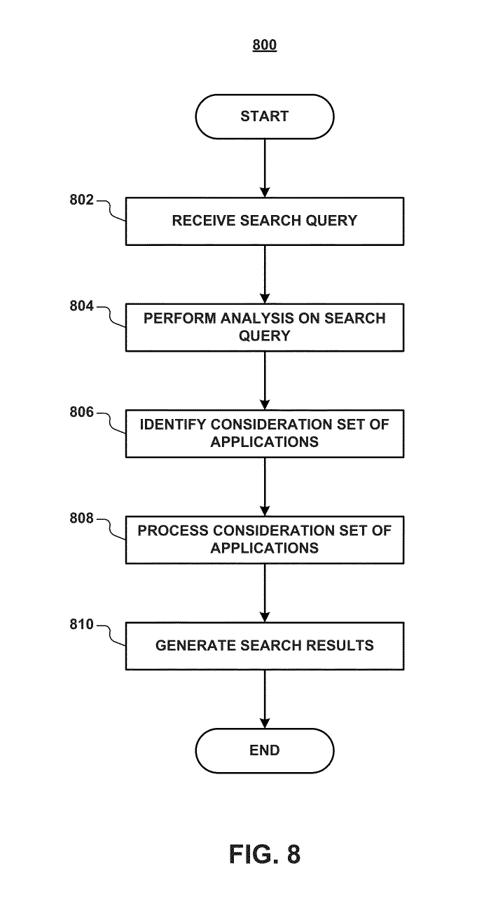

FIG. 8 shows an example method 800 for performing a search for applications in some embodiments. The method 800 is described with reference to the application search module 142 of FIG. 6. In step 802, the query analysis module 602 receives a query wrapper (containing a search query 608) generated by a user device 110. The search query 608 may include information to assist in the search (e.g., information that may assist in identifying one or more applications of interest to a user of the user device 110), an identifier of the user device 110 that provided the search query 608, and/or an identifier of the user associated with the user device 110.

In step 804, the query analysis module 602 analyzes the search query 608. In step 806, the set generation module 604 identifies a consideration set of application records included in the application record data store 144 (i.e., identifies a consideration set of applications referenced by the application records) based on the search query 608 (e.g., based on an output from the query analysis module 602).

In step 808, the set processing module 606 processes the consideration set of application records (i.e., the consideration set of applications). The set processing module 606 generates a result score for each of the application records included in the consideration set (i.e., for the application referenced by the respective application record). The set processing module 606 may further select one or more application records (i.e., applications) from the consideration set based on the result scores associated with the application records (i.e., the applications). For example, the set processing module 606 may select one or more application records (i.e., applications) having the largest result scores.

The set processing module 606 may also select one or more application download addresses (e.g., access mechanisms that allow a user and/or a user device 110 to download or learn more about one or more applications) from the selected application records.

In step 810, the set processing module 606 generates search results from the processed (i.e., scored and in some cases reduced in size using result scores) consideration set. The search results may include a list of the selected application download addresses.

FIG. 9 is a functional block diagram that illustrates example interactions between the user device 110, the advertisement system 106, and the search system 108 in some embodiments. The functional block diagram of FIG. 9 also illustrates interactions between one or more advertiser devices 902 and the advertisement system 106. As described above, the user device 110 transmits a query wrapper including a search query 148 to the application search module 142. The application search module 142 generates search results and transmits the search results to the user device 110.

The record generation module 136 receives advertisement data from the advertiser device(s) 902 and generates advertisement records based on the advertisement data received from the advertiser device(s) 902. The record generation module 136 stores the advertisement records in the advertisement data store 140. The advertisement generation module 138 may receive the query wrapper, the search results, data from the advertisement data store 140 (e.g., advertisement records), and data from the application record data store 144 (e.g., application records). The advertisement generation module 138 may generate one or more advertisements, or ad(s), based on data included in the query wrapper, data included in the search results, the data included in the advertisement data store 140, and the data included in the application record data store 144. As shown in FIG. 9, the advertisement generation module 138 transmits the advertisement(s), or ad(s), to the user device 110.

The advertiser device(s) 902 may be used by advertisers to generate advertisement data. As described herein, the advertiser device(s) 902 transmit the advertisement data to the advertisement system 106. The record generation module 136 generates one or more advertisement records based on the advertisement data received from the advertiser device(s) 902. The advertiser device(s) 902 may provide an interface (e.g., a GUI) that may be used by the advertisers to generate the advertisement data to be included in the advertisement records. The GUI may allow the advertisers to upload advertisement content and input advertisement parameters (e.g., targeting parameters and/or targeting parameter functions) and other information included in an advertisement record. The GUI may include a set of text fields, check boxes, or other user interface elements for generating advertisement data to be included in an advertisement record.

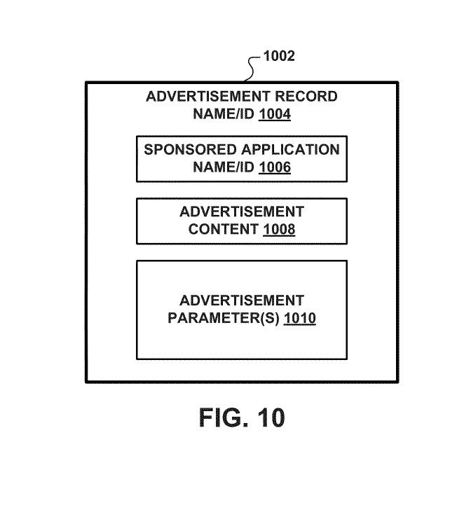

FIG. 10 illustrates an example advertisement record 1002 in some embodiments. The advertisement record 1002 may include a variety of different types of data related to an advertisement 150. In the example of FIG. 10, the advertisement record 1002 includes an advertisement record name/ID 1004, a sponsored application name/ID 1006, advertisement content 1008, and one or more advertisement parameters 1010. The advertisement record 1002 may represent data stored in the advertisement data store 140 that is related to an advertisement 150. The advertisement data store 140 may include one or more advertisement records each having a structure that is similar to that of the advertisement record 1002. Put another way, the advertisement data store 140 may include one or more advertisement records each indicating, for example, an advertisement record name/ID 1004, a sponsored application name/ID 1006, advertisement content 1008, and one or more advertisement parameters 1010.

The advertisement record name/ID 1004 identifies the advertisement record 1002 among other advertisement records included in the advertisement data store 140. For example, the advertisement record name/ID 1004 may uniquely identify the advertisement record 1002. The advertisement record name/ID 1004 may be a string of alphabetic, numeric, and/or symbolic characters (e.g., punctuation marks) that uniquely identify the advertisement record 1002 in which the advertisement record name/ID 1004 is included. In some examples, an advertiser may generate the advertisement record name/ID 1004. The advertiser may further access and update the advertisement record 1002 using the advertisement record name/ID 1004. In various embodiments, the advertisement identifier that is received by the revenue attribution module 104 as described herein may be the advertisement record name/ID 1004.

The sponsored application name/ID 1006 identifies a sponsored application associated with the advertisement record 1002. As described herein, the advertisement content 1008 and the advertisement parameter(s) 1010 of the advertisement record 1002 may be directed to advertising the sponsored application identified by the sponsored application name/ID 1006. The sponsored application name/ID 1006 may include data that identifies the sponsored application, such as a name of the sponsored application and/or an application ID associated with the sponsored application.

Sponsored applications may be associated with an advertisement record in the advertisement data store 140 and an application record in the application record data store 144. For example, an advertisement record in the advertisement data store 140 may include advertisement data related to a sponsored application. Additionally, an application record in the application record data store 144 may include application data related to the same sponsored application. Some of the applications described by application records included in the application record data store 144 may not be associated with an advertisement record included in the advertisement data store 140, since every application in the application record data store 144 may not be sponsored by an advertiser.

The sponsored application name/ID 1006 of the advertisement record 1002 may correspond to an application name and/or an application ID of an application record in the application record data store 144. For example, the advertisement record 1002 may include a sponsored application name “ANGRY BIRDS” having an ID, or ID number, “ID#1.” Accordingly, the advertisement record 1002 may be an advertisement record for the application named “ANGRY BIRDS®” by Rovio Entertainment Limited. The application record data store 144 may include an application record (e.g., the application record 710 of FIG. 7B) including application data for the “ANGRY BIRDS®” application. For example, the application record data store 144 may include an application record having an application name “ANGRY BIRDS” and an application ID, or ID number, “ID#1,” which corresponds to the sponsored application name/ID of the advertisement record 1002 in this example. As described herein, the advertisement system 106 (e.g., the advertisement generation module 138) may determine whether to generate an advertisement 150 for a sponsored application based on data from both an advertisement record and an application record associated with the sponsored application.

The advertisement record 1002 also includes advertisement content 1008. The advertisement content 1008 may include data in the advertisement record 1002 that is used by the advertisement system 106 (e.g., the advertisement generation module 138) to generate an advertisement 150 for the sponsored application referenced by the advertisement record 1002. For example, the advertisement content 1008 may include text associated with the sponsored application, such as a description of the sponsored application and a name of a developer of the sponsored application. In some examples, the advertisement content 1008 may include text indicating to a user that the advertisement 150 generated by the advertisement system 106 is an advertisement for the sponsored application, instead of a search result generated in response to a search query 148. For example, the advertisement content 1008 may include text, such as “Sponsored Application,” “Sponsored Result,” or “Advertisement,” which may be displayed on a user device 110 along with other information in the advertisement 150. In some examples, the advertisement content 1008 may include a message prompting a user to download the sponsored application (e.g., “Download Now!”).

The advertisement content 1008 may include images, animations, and videos associated with the sponsored application. An image may include an application icon that may be displayed on a mobile device (e.g., the user device 110). An application icon may be an image that represents the sponsored application. An image may also include screenshots of the sponsored application. Animations may include a series of images, such as screenshots or other images associated with the sponsored application. Videos may include, but are not limited to, demonstrations of the sponsored application and gameplay footage of the sponsored application. Generally, the advertisement content 1008 described above may include any manually-input content and/or any auto-populated content. Additionally, the advertisement content 1008 may specify any of one or more formats for a corresponding advertisement 150, such as, for example, still image, video, animation, and other formats. Moreover, the advertisement content 1008 may specify different formats for advertisements 150 that are new or are being generated on a trial (e.g., “test drive”) basis, relative to existing advertisements 150.

The advertisement content 1008 may also include links to locations from which the sponsored application may be downloaded. For example, the advertisement content 1008 may include hyperlinks to one or more digital distribution platforms from which the sponsored application may be downloaded. The advertisement 150 transmitted (e.g., served) to a user device 110 may include one or more links that a user of the user device 110 may select in order download the sponsored application to the user device 110.

The advertisement record 1002 also includes advertisement parameter(s) 1010. The advertisement parameter(s) 1010 may include one or more of a variety of different targeting parameters including, but not limited to, keyword targeting parameters and platform targeting parameters. The advertisement record 1002 may also include a targeting parameter function that defines which of the targeting parameter(s) should be satisfied in order for the advertisement generation module 138 to generate an advertisement 150 based on the advertisement content 1008 of the advertisement record 1002. Put another way, the advertisement generation module 138 may determine whether to generate an advertisement 150 for a sponsored application of the advertisement record 1002 based on whether one or more of the targeting parameter(s) of the advertisement record 1002 (e.g., of the advertisement parameter(s) 1010) are satisfied. In general, the advertisement generation module 138 may generate an advertisement 150 for a sponsored application of an advertisement record when one or more targeting parameters of the advertisement record are satisfied.

Example targeting parameters, such as keyword targeting parameters and platform targeting parameters, are now described in turn. A keyword targeting parameter may be a condition that is satisfied when one or more keywords are included in the search query 148. The one or more keywords may be included in the advertisement record 1002. The one or more keywords may be words specified by an advertiser (e.g., using an advertiser device 902). For example, the advertiser may indicate that the sponsored application of the advertisement record 1002 should be advertised when the advertisement generation module 138 identifies one or more of the keywords in the search query 148.

A platform targeting parameter may be a condition that is satisfied when an operating system of the user device 110 that generated the search query 148 matches an operating system listed in the advertisement record 1002. The advertisement generation module 138 may determine the operating system of the user device 110 based on information included in the query wrapper transmitted to the advertisement system 106 by the user device 110. Platform targeting parameters may also include conditions related to a type of the user device 110 that generated the search query 148 and/or a web-browser running on the user device 110.

Although keyword targeting parameters and platform parameters are described above, targeting parameters may include additional parameters, such as geographic targeting parameters. A geographic targeting parameter may be a condition that is satisfied based on a location of the user device 110 that generated the search query 148, which may be indicated in the query wrapper. Additional targeting parameters (e.g., time-slotting, day-parting, category, contextual, demographic, behavioral, and partner parameters) can also be implemented.

As described above, the advertisement parameter(s) 1010 may include a targeting parameter function that defines which of the targeting parameter(s) of the advertisement record 1002 should be satisfied in order for the advertisement system 106 to generate an advertisement 150. The targeting parameter function may include one or more of the targeting parameter(s). In some examples, the targeting parameter function may include a single targeting parameter (e.g., in cases where the advertisement parameter(s) 1010 include a single targeting parameter). In these examples, the advertisement generation module 138 may generate the advertisement 150 for the sponsored application of the advertisement record 1002 based on satisfaction of the single targeting parameter included in the advertisement record 1002. In other examples, the targeting parameter function may include a single targeting parameter selected from multiple targeting parameters included in the advertisement parameter(s) 1010.

In still other examples, the targeting parameter function may include multiple different targeting parameters (e.g., in cases where the advertisement parameter(s) 1010 include multiple targeting parameters). In these examples, the advertisement generation module 138 may generate an advertisement 150 for the sponsored application of the advertisement record 1002 when the multiple targeting parameters of the advertisement record 1002 are satisfied. In the above-described examples, the one or more targeting parameters may include one or more keyword targeting parameters and one or more platform targeting parameters. In these examples, the targeting parameter function may include a Boolean function.

The advertisement record 1002 may include additional one or more advertisement parameters that may be defined by an advertiser. The additional advertisement parameter(s) may include timing parameters, budget parameters, and user parameters. The timing parameters may define date(s) and/or time(s) of day at which advertising for the sponsored application should start and/or stop. The budget parameters may indicate a total advertising budget, an advertisement bid price, or other budget parameters associated with the sponsored application. The user parameters may specify which of one or more languages associated with the user's search query 148 will cause the advertisement generation module 138 to generate an advertisement 150 for the sponsored application. The user parameters may also define whether the advertisement generation module 138 will generate and provide the same advertisement 150 to a particular user more than once. Additional advertisement parameters (e.g., time-slotting, day-parting, category, geographical, contextual, demographic, behavioral, platform, device, and partner parameters) have also been previously described.

In some implementations, the advertiser device(s) 902 of FIG. 9 may be used by advertisers to generate any of the above data that may be included in the advertisement record 1002. For example, the advertiser device(s) 902 may be used by the advertisers to generate the advertisement record name/ID 1004, the sponsored application name/ID 1006, the advertisement content 1008, and the advertisement parameter(s) 1010. The record generation module 136 may provide an interface (e.g., a GUI) to the advertiser device(s) 902 that may be used by the advertisers to generate the advertisement data. The GUI may include interface elements that allow the advertisers to upload advertisement content, input advertisement parameters (e.g., targeting parameters and targeting parameter functions), and input other information included in the advertisement record 1002.

The GUI may include interface elements (e.g., text boxes) for specifying the advertisement record name/ID 1004 and the sponsored application name/ID 1006. The GUI may also include other interface elements for specifying targeting parameters, such as keyword targeting parameters. For example, the GUI may include text fields (e.g., text boxes) for entering keywords that define keyword targeting parameters. The GUI may also include an interface element, such as a button, that the advertisers may use to submit the data entered into the GUI to the record generation module 136. The record generation module 136 may generate the advertisement record 1002 in the advertisement data store 140 based on the data received from the advertiser device(s) 902.

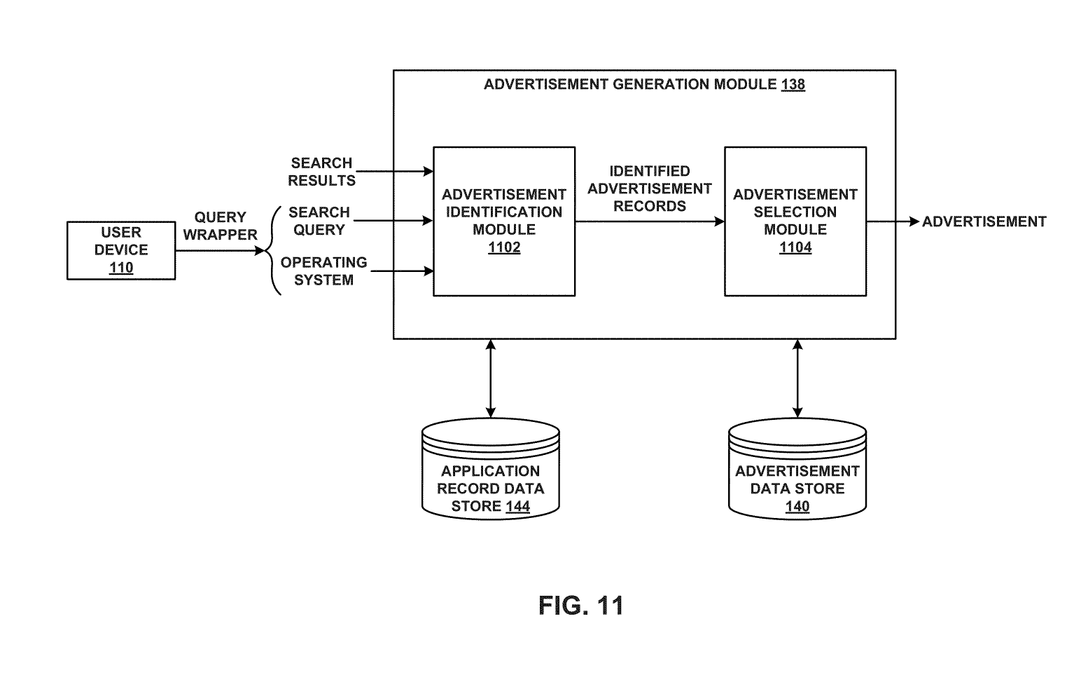

FIG. 11 is a functional block diagram of an example advertisement generation module 138 that includes an advertisement identification module 1102 (hereinafter, “identification module 1102”) and an advertisement selection module 1104 in some embodiments. The identification module 1102 may identify one or more advertisement records included in the advertisement data store 140 based on search results, data included in a query wrapper (e.g., a search query 148 and/or various properties of the user device 110, such as an operating system of the user device 110), and data included in the application record data store 144. For example, the identification module 1102 may identify one or more advertisement records having targeting parameters that are satisfied based on the search results, the data included in the query wrapper, and data included in the application record data store 144. The advertisement selection module 1104 selects one or more of the identified advertisement record(s) and generates one or more advertisements 150 based on the selected advertisement record(s). For example, the advertisement selection module 1104 may select one or more of the identified advertisement record(s) in response to a single search (i.e., in response to a single search query 148), because targeting parameter function(s) for those advertisement record(s) are satisfied. The advertisement selection module 1104 may select which advertisements 150 to generate from a list of different possible advertisements 150 based on budget parameters (e.g., advertising a sponsored application with a highest bid price) and/or advertisement popularity (e.g., as specified by a corresponding advertisement record). In some examples, the advertisement selection module 1104 may select which advertisements 150 to generate based on any combination of a bid price, relevance to a search query 148, a release date and/or an age of an advertisement 150, remaining impressions to fulfill (e.g., how many times a particular advertisement 150 is to be generated), as well as any number of other considerations.

The advertisement generation module 138 (e.g., the identification module 1102 and the advertisement selection module 1104) may be configured to generate an advertisement 150 for each set of search results generated by the search system 108. For example, the identification module 1102 may identify one or more advertisement records in response to receiving a query wrapper including a search query 148 and search results generated using the search query 148. For example, the identification module 1102 may identify one or more advertisement records that have targeting parameter(s) (e.g., targeting parameter function(s)) that are satisfied by the search results and/or data included in the query wrapper. In some examples, the identification module 1102 may identify a single advertisement record having one or more targeting parameters that are satisfied. In other examples, the identification module 1102 may identify multiple advertisement records each having one or more targeting parameters that are each satisfied.

The identification module 1102 may check multiple advertisement records in the advertisement data store 140 to determine whether any of the multiple advertisement records have targeting parameters that are satisfied. In some examples, the identification module 1102 may check most, or all, of the advertisement records in the advertisement data store 140 to determine whether any of the advertisement records have targeting parameters that are satisfied. For example, the identification module 1102 may initially determine whether one or more targeting parameters (e.g., a targeting parameter function) of a first advertisement record are satisfied. If the targeting parameter(s) of the first advertisement record are satisfied, the identification module 1102 may identify the advertisement record as being a candidate for advertisement generation. After determining whether the targeting parameter(s) of the first advertisement record are satisfied, the identification module 1102 may determine whether one or more targeting parameters of a second advertisement record are satisfied. The identification module 1102 may continue to determine whether targeting parameter(s) of additional advertisement records (e.g., most or all) are satisfied.

The advertisement selection module 1104 selects one of the identified advertisement records identified by the identification module 1102. The advertisement selection module 1104 may generate an advertisement 150 based on the selected advertisement record. For example, the advertisement selection module 1104 may generate an advertisement 150 that includes advertisement content from the selected advertisement record. In some examples, the advertisement selection module 1104 may generate an advertisement 150 based on data included in the application record data store 144. For example, the advertisement selection module 1104 may retrieve text and/or images from an application record included in the application record data store 144 that references a sponsored application of a selected advertisement record in order to generate an advertisement 150 for the sponsored application.

The advertisement selection module 1104 may transmit (e.g., serve) the generated advertisement 150 to the user device 110 that generated the search query 148. Accordingly, the user device 110 that generated the search query 148 may receive the generated advertisement 150 along with search results including a list of applications. The user device 110 may display the advertisement 150 along with the search results. Although the advertisement selection module 1104 may generate a single advertisement 150 in some implementations, in other implementations, the advertisement selection module 1104 may select multiple identified advertisement records and generate multiple advertisements 150 based on the multiple identified advertisement records.

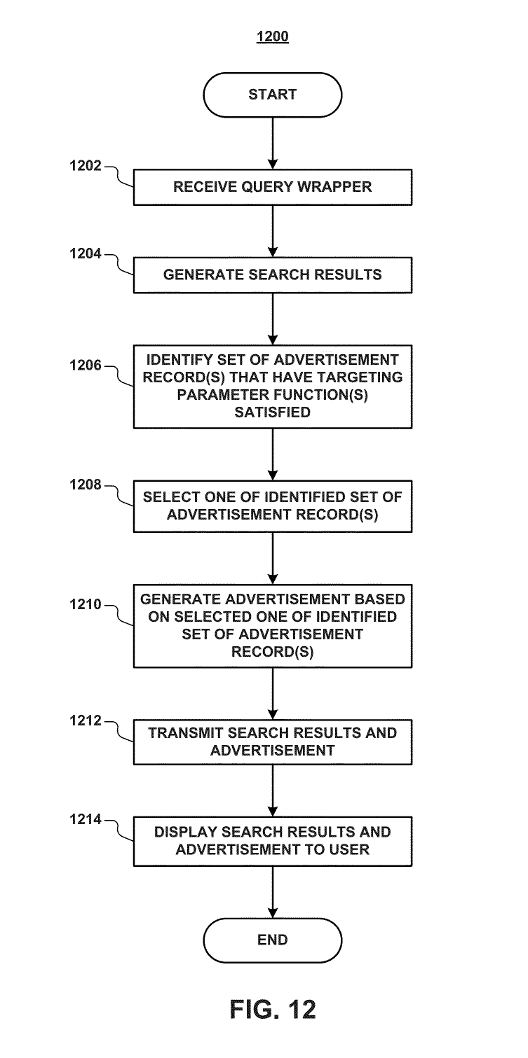

FIG. 12 illustrates a method 1200 for generating search results and an advertisement 150 for the search results in some embodiments. The method 1200 is described with reference to the application search module 142 and the advertisement generation module 138 of FIGS. 1 and 11. In step 1202, the application search module 142 and the identification module 1102 receive a query wrapper including a search query 148 from the user device 110. In step 1204, the application search module 142 generates search results based on the received search query 148.

In step 1206, the identification module 1102 identifies a set of one or more advertisement records that include targeting parameter function(s) that are satisfied. For example, the identification module 1102 may determine that the targeting parameter function(s) of the identified set of advertisement record(s) are satisfied based on the search results, data included in the query wrapper, and/or data included in the application record data store 144. In step 1208, the advertisement selection module 1104 selects one of the identified set of advertisement record(s). For example, the advertisement selection module 1104 may select the one of the identified set of advertisement record(s) based on budget parameters, advertisement popularity, or other considerations, as described herein. In step 1210, the advertisement selection module 1104 generates an advertisement 150 based on advertisement content of the selected one of the identified set of advertisement record(s).

In step 1212, the application search module 142 transmits the search results to the user device 110 that generated the search query 148. Additionally, the advertisement selection module 1104 transmits (e.g., serves) the advertisement 150 to the user device 110 that generated the search query 148. In step 1214, the user device 110 that generated the search query 148 displays the search results and the advertisement 150 to a user of the user device 110.

An advertiser may generate a custom advertisement record with a variety of different targeting parameters and targeting parameter functions. In some examples, the advertiser may generate an advertisement record that includes a single targeting parameter. In other examples, the advertiser may generate an advertisement record that includes a targeting parameter function including multiple targeting parameters as part of a Boolean logic function.

Some example targeting parameter functions are described above with respect to FIGS. 1, 10 and 12. An advertiser may generate a variety of different targeting parameter functions including different numbers and types of targeting parameters and different logical operators including, but not limited to, an AND logical operator, an OR logical operator, an XOR logical operator, and a negation logical operator (e.g., an inverter).

Although the advertisement system 106 is described herein as generating an advertisement 150 for a user device 110 in response to a search query 148, in some examples, the advertisement system 106 may refrain from generating an advertisement 150. For example, the advertisement system 106 may refrain from generating an advertisement 150 when the identification module 1102 does not identify an advertisement record that has a targeting parameter function that is satisfied. In these examples, the search system 108 may generate search results, but the advertisement system 106 may refrain from generating an advertisement 150 to be displayed along with the search results.

FIG. 13 is a functional block diagram of a digital device 1300 in some embodiments. The digital device 1300 includes a data processing device 1302 (e.g., a processor), a memory system 1304 (e.g., non-transitory memory), a storage system 1306, a communication network interface 1308, an I/O interface 1310, and a display interface 1312 communicatively coupled to a bus 1314. The data processing device 1302 is in communication with the memory system 1304, the storage system 1306, the communication network interface 1308, the I/O interface 1310, and the display interface 1312. The data processing device 1302 is also configured to execute executable instructions (e.g., programs stored on the memory system 1304 or the storage system 1306). In some examples, the data processing device 1302 includes circuitry or any data processing device capable of processing the executable instructions.

The memory system 1304 is any non-transitory memory configured to store data. Some examples of the memory system 1304 are storage devices, such as RAM or read-only memory. The memory system 1304 can include a RAM cache. The data included within the memory system 1304 may be cleared or ultimately transferred to the storage system 1306.

The storage system 1306 is any storage configured to retrieve and store data. Some examples of the storage system 1306 are flash drives, hard drives, optical drives, and/or magnetic tape. The storage system 1306 may include non-transitory media. In some implementations, the digital device 1300 includes the memory system 1304 in the form of RAM and the storage system 1306 in the form of flash memory. Both the memory system 1304 and the storage system 1306 include computer readable media which may store instructions or programs that are executable by a computer processor including the data processing device 1302.

The communication network interface (“com. network interface”) 1308 can be coupled to a network (e.g., the network 112) via the bus 1314. The communication network interface 1308 may support communication over an Ethernet connection, a serial connection, a parallel connection, or an ATA connection, for example. The communication network interface 1308 may also support wireless communication (e.g., 802.11a/b/g/n, WiMax). Moreover, the communication network interface 1308 can support many wired and wireless standards.

The optional input/output (“I/O”) interface 1310 is any device that receives input from a user and outputs data. The optional display interface 1312 is any device that is configured to output graphics and data to a display. In some examples, the optional display interface 1312 is a graphics adapter. While not all digital devices include either the optional I/O interface 1310 or the optional the display interface 1312, the digital device 1300 may include either, both, or none.

The hardware elements of the digital device 1300 are not limited to those depicted in FIG. 13. In some examples, the digital device 1300 may include more or less hardware elements than those depicted. Further, the hardware elements of the digital device 1300 may share functionality and still be within various implementations described herein. In some examples, encoding and/or decoding may be performed by the data processing device 1302 and/or a co-processor located on a graphics processing unit (GPU) (e.g., a GPU developed by NVIDIA Corporation).

The above-described functions and components can include instructions that are stored on a storage medium such as a computer readable medium (e.g., a non-transitory computer readable medium). The instructions can be retrieved and executed by a data processing device. Some examples of the instructions are software, program code, and firmware. Some examples of the storage medium are memory devices, tape, disks, integrated circuits, and servers. The instructions are operational when executed by the data processing device to direct the data processing device to operate in accord with embodiments of the present disclosure. Those skilled in the art are familiar with instructions, data processing device(s), and storage media.

The present disclosure is described above with reference to example embodiments. It will be apparent to those skilled in the art that various modifications may be made and other embodiments can be used without departing from the broader scope of the present disclosure. Therefore, these and other variations upon the example embodiments are intended to be covered by the present disclosure.

1. A system comprising:
one or more computing devices comprising:
a preinstall partner module configured to provide an application and a partner attribution identifier to a partner device, the partner attribution identifier configured to identify a preinstall partner and configured to be stored on a user device before the user device is first sold to an end user, the application configured to assist in presenting an advertisement;
an advertisement generation module configured to select the advertisement for display on the user device, the advertisement being associated with an advertisement identifier;
a partner attribution identifier module configured to receive the partner attribution identifier from the user device and associate the advertisement identifier with the partner attribution identifier; and
a revenue attribution module configured to receive advertisement revenue information associated with revenue related to the advertisement, the advertisement revenue information including the advertisement identifier, the revenue attribution module further configured to identify the preinstall partner using the partner attribution identifier associated with the advertisement identifier, and to allocate a share of the revenue to the preinstall partner.

2. The system of claim 1, the one or more computing devices further comprises an application search module configured to receive a search query from the application on the user device after the user device is sold to the end user, to provide search results to the user device, the search results being determined using the search query, and to provide the selected advertisement to the user device.

3. The system of claim 2, wherein the search query includes the partner attribution identifier.

4. The system of claim 1, wherein the partner attribution identifier is stored in read-only memory on the user device.

5. The system of claim 1, the one or more computing devices further comprises a partner identification module configured to store an association between the partner attribution identifier and the preinstall partner.

6. The system of claim 1, wherein the revenue attribution module is further configured to generate a report identifying at least a portion of the revenue to be provided to the preinstall partner.

7. The system of claim 1, the one or more computing devices further comprises a revenue rules data store configured to store at least one revenue rule associated with revenue attribution of the preinstall partner, wherein the revenue attribution module is further configured to retrieve the at least one revenue rule from the revenue rules data store, and wherein to allocate the share of the revenue to the preinstall partner, the revenue attribution module is configured to determine an allocation of a portion of the revenue to the preinstall partner using the at least one revenue rule.

8. The system of claim 1, wherein the advertisement identifier comprises a session identifier or a timestamp associated with selection of the advertisement or sending of the advertisement to the user device.

9. The system of claim 1, wherein the advertisement comprises advertisement linking information to enable the application on the user device to retrieve the advertisement.

10. The system of claim 1, the one or more computing devices further comprises a security module configured to receive a security identifier from the user device and authenticate the security identifier.

11. A method comprising:
providing an application and a partner attribution identifier to a partner device, the partner attribution identifier configured to identify a preinstall partner and configured to be stored on a user device before the user device is first sold to an end user, the application configured to assist in presenting an advertisement;
selecting the advertisement for display on the user device, the advertisement being associated with an advertisement identifier;
receiving the partner attribution identifier from the user device;
associating the advertisement identifier with the partner attribution identifier;
receiving advertisement revenue information associated with revenue related to the advertisement, the advertisement revenue information including the advertisement identifier;
identifying the preinstall partner using the partner attribution identifier associated with the advertisement identifier; and
allocating a share of the revenue to the preinstall partner.

12. The method of claim 11, further comprising:
receiving a search query from the application on the user device after the user device is sold to the end user;
providing search results to the user device, the search results being determined using the search query; and
providing the selected advertisement to the user device.

13. The method of claim 12, wherein the search query includes the partner attribution identifier.

14. The method of claim 11, wherein the partner attribution identifier is stored in read-only memory on the user device.

15. The method of claim 11, further comprising storing an association between the partner attribution identifier and the preinstall partner.

16. The method of claim 11, further comprising generating a report identifying at least a portion of the revenue to be provided to the preinstall partner.

17. The method of claim 11, further comprising:
storing at least one revenue rule associated with revenue attribution of the preinstall partner; and
retrieving the at least one revenue rule,
wherein allocating the share of the revenue to the preinstall partner comprises determining an allocation of a portion of the revenue to the preinstall partner using the at least one revenue rule.

18. The method of claim 11, wherein the advertisement identifier comprises a session identifier or a timestamp associated with selection of the advertisement or sending of the advertisement to the user device.

19. The method of claim 11, wherein the advertisement comprises advertisement linking information to enable the application on the user device to retrieve the advertisement.

20. The method of claim 11, further comprising:
receiving a security identifier from the user device; and
authenticating the security identifier.

21. A non-transitory computer readable medium comprising executable instructions, the instructions being executable by a data processing device to perform a method, the method comprising:
providing an application and a partner attribution identifier to a partner device, the partner attribution identifier configured to identify a preinstall partner and configured to be stored on a user device before the user device is first sold to an end user, the application configured to assist in presenting an advertisement;
selecting the advertisement for display on the user device, the advertisement being associated with an advertisement identifier;
receiving the partner attribution identifier from the user device;
associating the advertisement identifier with the partner attribution identifier;
receiving advertisement revenue information associated with revenue related to the advertisement, the advertisement revenue information including the advertisement identifier;
identifying the preinstall partner using the partner attribution identifier associated with the advertisement identifier; and
allocating a share of the revenue to the preinstall partner.
